(19) United States
(12) Patent Application Publication
(10) Pub. No.: US 2023/0084136 A1
(43) Pub. Date: Mar. 16, 2023

(54) DETERMINING AND/OR ENACTING AERIAL VEHICLE CONSTELLATIONS FOR ENABLING POSITIONING

(71) Applicant: HERE Global B.V., Eindhoven (NL)

(72) Inventors: Marko Luomi, Lempaala (FI); Henri Jaakko Julius Nurminen, Tampere (FI); Pavel Ivanov, Tampere (FI); Lauri Aarne Johannes Wirola, Tampere (FI)

(21) Appl. No.: 17/473,142

(22) Filed: Sep. 13, 2021

(51) Int. Cl. G01S 5/06; G01S 5/02; G01S 19/42

(52) U.S. Cl. CPC G01S 5/06; G01S 5/0289; G01S 19/423

(57) ABSTRACT

A device generates a first plurality of aerial vehicle (AV) constellations about a geographic area and determines respective positioning scores for each AV constellation. The respective positioning score is determined based at least in part on a measure of positioning accuracy for positioning enabled by the AV constellation at position(s) of interest within the geographic area. The device generates a second plurality of AV constellations based on the first plurality and the respective positioning scores by modifying one or more of the AV constellations of the first plurality using random location perturbations. The device determines respective positioning scores for each AV constellation of the second plurality. The device selects a preferred AV constellation from a group of selectable constellations based on the respective positioning score of the preferred AV constellation, the group of selectable constellations generated based at least in part on the first and/or second plurality of AV constellations.

### TECHNOLOGICAL FIELD

An example embodiment relates to determining an aerial vehicle (AV) constellation configured to enable positioning within a geographic area. An example embodiment relates to determining AV constellations configured to enable positioning within a geographic area and causing a set of AVs to operate in accordance with the determined AV constellation (e.g., form a physical AV constellation in and/or about the geographic area in accordance with the determined AV constellation).

### BACKGROUND

In various scenarios, emergency personnel may enter a geographic area including a building or venue during an emergency situation. Global navigation satellite system (GNSS) -based positioning may not be available or may not be available with sufficient accuracy in the geographic area. The geographic area may not include infrastructure or the infrastructure may not be available (e.g., during the emergency situation) to enable other forms of positioning within the geographic area (e.g., radio-based positioning). In such scenarios, performing accurate positioning within the geographic area may be difficult.

### BRIEF SUMMARY

Various embodiments provide methods, apparatus, systems, and computer program products for determining and/or causing physical enactment of AV constellations configured to enable positioning (e.g., radio-based positioning) within a geographic area. For example, the geographic area may be and/or comprise a building (e.g., a multi-story building) or venue. In various embodiments, the determined AV constellation is configured to provide positioning of maximum and/or at least a threshold accuracy at position(s) of interest within the geographic area when AVs configured to enable positioning is are respectively located at the AV locations of the AV constellation. In various embodiments, the position(s) of interest comprise at least one position of interest and/or one or more positions of interest. In various embodiments, an AV constellation is defined by and/or a data structure comprising and/or indicating a respective three-dimensional location in and/or near the geographic area for each AV of a set number of AVs (e.g., the number of AVs available for generating a physical AV constellation in accordance with the AV locations of the AV constellation). In various embodiments, a preferred AV constellation is determined by randomly generating a first plurality of AV constellations and determining a respective positioning score for each AV constellation of the first plurality of AV constellations. The respective positioning score for an AV constellation characterizes the positioning (e.g., the positioning accuracy) at position(s) of interest within the geographic area that is (theoretically) enabled by the AV constellation. A second plurality of AV constellations is then generated by perturbing the respective AV locations of one or more AV constellations of the first plurality of AV constellations. For example, an AV constellation of the first plurality of AV constellations is selected using a weighted random selection technique where the weight associated with the AV constellation is determined based at least on the respective positioning score for the AV constellation. Respective positioning scores are determined for the AV constellations of the second plurality of AV constellations. A preferred AV constellation is selected from a group of selectable constellations comprising and/or generated based on the first plurality of AV constellations, the second plurality of AV constellations, and/or a plurality of AV constellations generated based on the second plurality of AV constellations and/or a successor thereof.

In various embodiments, travel paths for transporting the AVs from respective current locations thereof to the respective three-dimensional locations of the preferred AV constellation. In various embodiments, the travel paths are shortest paths from the respective current locations to the respective three-dimensional locations of the preferred AV constellations. In various embodiments, the travel paths are determined to avoid obstacles in the area based on obstacle information for the geographic area. In various embodiments, respective instructions are generated and provided (e.g., for receipt by the respective AVs) that are configured to cause the AVs to traverse the respective travel paths and/or enable positioning within the geographic area.

In an example embodiment, a network devices generates a first plurality of AV constellations about a geographic area. Each AV constellation comprises a set number of AVs with each AV of the set number of AVs associated with a randomly selected respective AV location. The first plurality of AV constellations is determined based at least in part on respective current locations of the set number of AVs and obstacle information for the geographic area. Each of the set number of AVs is configured to enable positioning within the geographic area. The network device determines respective positioning scores for AV constellations of the first plurality of AV constellations. The respective positioning score for an AV constellation of the first plurality of AV constellations is determined based at least in part on a measure of positioning accuracy at position(s) of interest within the geographic area. The network devices generates a second plurality of AV constellations based on the first plurality of AV constellations and the respective positioning scores. Generating an AV constellation of the second plurality of AV constellations comprises selecting a first AV constellation randomly from the first plurality of AV constellations based on the respective positioning scores for the first plurality of AV constellations, and modifying the first AV constellation by adjusting one or more respective locations of the set number of AVs by respective randomly selected location perturbations. The network devices determines the respective positioning scores for the AV constellations of the second plurality of AV constellations. The network devices selects a preferred AV constellation from a group of selectable constellations based on the respective positioning score of the preferred AV constellation. The group of selectable constellations is generated based at least in part on one or more of the first plurality of AV constellations or the second plurality of AV constellations.

According to an aspect of the present disclosure, a method for generating and/or determining a preferred AV constellation to enable positioning at position(s) of interest within a geographic area is provided. In an example embodiment, the method comprises generating, by a network device, a first plurality of AV constellations about a geographic area. Each AV constellation comprises a set number of AVs with each AV of the set number of AVs associated with a randomly selected respective location. The first plurality of AV constellations is determined based at least in part on respective current locations of the set number of AVs and obstacle information for the geographic area. Each of the set number of AVs is configured to enable positioning within the geographic area. The method further comprises determining, by the network device, respective positioning scores for AV constellations of the first plurality of AV constellations. The respective positioning score for an AV constellation of the first plurality of AV constellations is determined based at least in part on a measure of positioning accuracy for at least one position of interest within the geographic area. The method further comprises generating, by the network device, a second plurality of AV constellations based on the first plurality of AV constellations and the respective positioning scores. Generating an AV constellation of the second plurality of AV constellations comprises selecting a first AV constellation randomly from the first plurality of AV constellations based on the respective positioning scores for the first plurality of AV constellations, and modifying the first AV constellation by adjusting one or more respective locations of the set number of AVs by respective randomly selected location perturbations. The method further comprises determining, by the network device, the respective positioning scores for the AV constellations of the second plurality of AV constellations; and selecting, by the network device, a preferred AV constellation from a group of selectable constellations based on the respective positioning score of the preferred AV constellation. The group of selectable constellations is generated based at least in part on one or more of the first plurality of AV constellations or the second plurality of AV constellations.

In an example embodiment, the method further comprises determining respective travel paths from the respective current locations of the set number of AVs to respective locations of the set number of AVs corresponding to the preferred AV constellation.

In an example embodiment, the method further comprises providing respective instructions for receipt by respective AVs of the set number of AVs, the respective instructions configured to cause the respective AVs to each traverse one of the respective travel paths.

In an example embodiment, the method further comprises receiving determined obstacle data provided by an AV of the set number of AVs, the determined obstacle data determined by the AV as the AV traversed a respective travel path; and incorporating the determined obstacle data into the obstacle information for the geographic area.

In an example embodiment, a probability that the first AV constellation is selected from the first plurality of random AV constellations is determined based on the respective positioning score associated with the first AV constellation.

In an example embodiment, the geographic area comprises a building or venue.

In an example embodiment, the obstacle information for the geographic area comprises an indication of dimensions of building or venue and a positioning of the building or venue in the geographic area.

In an example embodiment, the at least one position of interest is a position of a device located within the geographic area.

In an example embodiment, each AV of the set number of AVs comprises one or more sensors configured to determine a three-dimensional location of the AV.

In an example embodiment, the measure of positioning accuracy is a geometric dilution of precision (GDOP) value.

In an example embodiment, the method further comprises iterating the steps of generating the second plurality of AV constellations and determining the respective positioning scores for the constellations of the second plurality of AV constellations until a convergence requirement is met, wherein the group of selectable constellations comprises a final second plurality of AV constellations generated during a final iteration of generating the second plurality of AV constellations.

In an example embodiment, at least one of the first plurality of AV constellations or the second plurality of AV constellations is filtered so as to only contain AV constellations that, for each AV of the set number of AVs, at least one potential travel path exists from the current location of the AV to a new AV location of the respective AV constellation, the at least one potential travel path having a length that is no longer than at least one (a) a set distance or (b) a set percentage longer than a shortest distance path from the current location of the AV to the AV location and having no obstacles located along the at least one potential travel path.

In an example embodiment, the set distance is equal to zero or the set percentage is equal to zero.

In an example embodiment, the obstacle information is a binary three-dimensional grid comprising a plurality of grid elements each corresponding to a respective volume of the geographic area and each associated with a respective binary value, the respective binary value configured to indicate whether the corresponding respective volume comprises an obstacle.

In an example embodiment, the method further comprises receiving at least one updated position of interest; determining a new preferred AV constellation based on the at least one updated position of interest; determining new respective travel paths from the respective current locations of the set number of AVs to the respective locations of the set number of AVs corresponding to the new preferred AV constellation; and providing new respective instructions for receipt by the respective AVs, the new respective instructions configured to cause the respective AVs to each traverse one of the new respective travel paths.

According to another aspect of the present disclosure, an apparatus is provided. In an example embodiment, the apparatus comprises at least one processor and at least one memory storing computer program code. The at least one memory and the computer program code are configured to, with the processor, cause the apparatus to at least generate a first plurality of AV constellations about a geographic area. Each AV constellation comprises a set number of AVs with each AV of the set number of AVs associated with a randomly selected respective location. The first plurality of AV constellations is determined based at least in part on respective current locations of the set number of AVs and obstacle information for the geographic area. Each of the set number of AVs is configured to enable positioning within the geographic area. The at least one memory and the computer program code are further configured to, with the processor, cause the apparatus to at least determine respective positioning scores for AV constellations of the first plurality of AV constellations. The respective positioning score for an AV constellation of the first plurality of AV constellations is determined based at least in part on a measure of positioning accuracy for at least one position of interest within the geographic area. The at least one memory and the computer program code are further configured to, with the processor, cause the apparatus to at least generate a second plurality of AV constellations based on the first plurality of AV constellations and the respective positioning scores. Generating an AV constellation of the second plurality of AV constellations comprises selecting a first AV constellation randomly from the first plurality of AV constellations based on the respective positioning scores for the first plurality of AV constellations, and modifying the first AV constellation by adjusting one or more respective locations of the set number of AVs by respective randomly selected location perturbations. The at least one memory and the computer program code are further configured to, with the processor, cause the apparatus to at least determine the respective positioning scores for the AV constellations of the second plurality of AV constellations; and select a preferred AV constellation from a group of selectable constellations based on the respective positioning score of the preferred AV constellation. The group of selectable constellations is generated based at least in part on one or more of the first plurality of AV constellations or the second plurality of AV constellations.

In an example embodiment, the at least one memory and the computer program code are further configured to, with the processor, cause the apparatus to at least determine respective travel paths from the respective current locations of the set number of AVs to respective locations of the set number of AVs corresponding to the preferred AV constellation.

In an example embodiment, the at least one memory and the computer program code are further configured to, with the processor, cause the apparatus to at least provide respective instructions for receipt by respective AVs of the set number of AVs, the respective instructions configured to cause the respective AVs to each traverse one of the respective travel paths.

In an example embodiment, the at least one memory and the computer program code are further configured to, with the processor, cause the apparatus to at least receive determined obstacle data provided by an AV of the set number of AVs, the determined obstacle data determined by the AV as the AV traversed a respective travel path; and incorporate the determined obstacle data into the obstacle information for the geographic area.

In an example embodiment, a probability that the first AV constellation is selected from the first plurality of random AV constellations is determined based on the respective positioning score associated with the first AV constellation.

In an example embodiment, the geographic area comprises a building or venue.

In an example embodiment, the obstacle information for the geographic area comprises an indication of dimensions of building or venue and a positioning of the building or venue in the geographic area.

In an example embodiment, the at least one position of interest is a position of a device located within the geographic area.

In an example embodiment, each AV of the set number of AVs comprises one or more sensors configured to determine a three-dimensional location of the AV.

In an example embodiment, the measure of positioning accuracy is a geometric dilution of precision (GDOP) value.

In an example embodiment, the at least one memory and the computer program code are further configured to, with the processor, cause the apparatus to at least iterate the steps of generating the second plurality of AV constellations and determining the respective positioning scores for the constellations of the second plurality of AV constellations until a convergence requirement is met, wherein the group of selectable constellations comprises a final second plurality of AV constellations generated during a final iteration of generating the second plurality of AV constellations.

In an example embodiment, at least one of the first plurality of AV constellations or the second plurality of AV constellations is filtered so as to only contain AV constellations that, for each AV of the set number of AVs, at least one potential travel path exists from the current location of the AV to a new AV location of the respective AV constellation, the at least one potential travel path having a length that is no longer than at least one (a) a set distance or (b) a set percentage longer than a shortest distance path from the current location of the AV to the AV location and having no obstacles located along the at least one potential travel path.

In an example embodiment, the set distance is equal to zero or the set percentage is equal to zero.

In an example embodiment, the obstacle information is a binary three-dimensional grid comprising a plurality of grid elements each corresponding to a respective volume of the geographic area and each associated with a respective binary value, the respective binary value configured to indicate whether the corresponding respective volume comprises an obstacle.

In an example embodiment, the at least one memory and the computer program code are further configured to, with the processor, cause the apparatus to at least receive at least one updated position of interest; determine a new preferred AV constellation based on the at least one updated position of interest; determine new respective travel paths from the respective current locations of the set number of AVs to the respective locations of the set number of AVs corresponding to the new preferred AV constellation; and provide new respective instructions for receipt by the respective AVs, the new respective instructions configured to cause the respective AVs to each traverse one of the new respective travel paths.

In still another aspect of the present disclosure, a computer program product is provided. In an example embodiment, the computer program product comprises at least one non-transitory computer-readable storage medium having computer-readable program code portions and/or computer-executable instructions stored therein. The computer-readable program code portions and/or computer-readable instructions comprise executable portions configured, when executed by a processor of an apparatus, to cause the apparatus to generate a first plurality of AV constellations about a geographic area. Each AV constellation comprises a set number of AVs with each AV of the set number of AVs associated with a randomly selected respective location. The first plurality of AV constellations is determined based at least in part on respective current locations of the set number of AVs and obstacle information for the geographic area. Each of the set number of AVs is configured to enable positioning within the geographic area. The computer-readable program code portions and/or computer-readable instructions comprise executable portions further configured, when executed by a processor of an apparatus, to cause the apparatus to determine respective positioning scores for AV constellations of the first plurality of AV constellations. The respective positioning score for an AV constellation of the first plurality of AV constellations is determined based at least in part on a measure of positioning accuracy for at least one position of interest within the geographic area. The computer-readable program code portions and/or computer-readable instructions comprise executable portions further configured, when executed by a processor of an apparatus, to cause the apparatus to generate a second plurality of AV constellations based on the first plurality of AV constellations and the respective positioning scores. Generating an AV constellation of the second plurality of AV constellations comprises selecting a first AV constellation randomly from the first plurality of AV constellations based on the respective positioning scores for the first plurality of AV constellations, and modifying the first AV constellation by adjusting one or more respective locations of the set number of AVs by respective randomly selected location perturbations. The computer-readable program code portions and/or computer-readable instructions comprise executable portions further configured, when executed by a processor of an apparatus, to cause the apparatus to determine the respective positioning scores for the AV constellations of the second plurality of AV constellations; and select a preferred AV constellation from a group of selectable constellations based on the respective positioning score of the preferred AV constellation. The group of selectable constellations is generated based at least in part on one or more of the first plurality of AV constellations or the second plurality of AV constellations.

In an example embodiment, the computer-readable program code portions and/or computer-readable instructions comprise executable portions further configured, when executed by a processor of an apparatus, to cause the apparatus to determine respective travel paths from the respective current locations of the set number of AVs to respective locations of the set number of AVs corresponding to the preferred AV constellation.

In an example embodiment, the computer-readable program code portions and/or computer-readable instructions comprise executable portions further configured, when executed by a processor of an apparatus, to cause the apparatus to provide respective instructions for receipt by respective AVs of the set number of AVs, the respective instructions configured to cause the respective AVs to each traverse one of the respective travel paths.

In an example embodiment, the computer-readable program code portions and/or computer-readable instructions comprise executable portions further configured, when executed by a processor of an apparatus, to cause the apparatus to receive determined obstacle data provided by an AV of the set number of AVs, the determined obstacle data determined by the AV as the AV traversed a respective travel path; and incorporate the determined obstacle data into the obstacle information for the geographic area.

In an example embodiment, a probability that the first AV constellation is selected from the first plurality of random AV constellations is determined based on the respective positioning score associated with the first AV constellation.

In an example embodiment, the geographic area comprises a building or venue.

In an example embodiment, the obstacle information for the geographic area comprises an indication of dimensions of building or venue and a positioning of the building or venue in the geographic area.

In an example embodiment, the at least one position of interest is a position of a device located within the geographic area.

In an example embodiment, each AV of the set number of AVs comprises one or more sensors configured to determine a three-dimensional location of the AV.

In an example embodiment, the measure of positioning accuracy is a geometric dilution of precision (GDOP) value.

In an example embodiment, the computer-readable program code portions and/or computer-readable instructions comprise executable portions further configured, when executed by a processor of an apparatus, to cause the apparatus to iterate the steps of generating the second plurality of AV constellations and determining the respective positioning scores for the constellations of the second plurality of AV constellations until a convergence requirement is met, wherein the group of selectable constellations comprises a final second plurality of AV constellations generated during a final iteration of generating the second plurality of AV constellations.

In an example embodiment, at least one of the first plurality of AV constellations or the second plurality of AV constellations is filtered so as to only contain AV constellations that, for each AV of the set number of AVs, at least one potential travel path exists from the current location of the AV to a new AV location of the respective AV constellation, the at least one potential travel path having a length that is no longer than at least one (a) a set distance or (b) a set percentage longer than a shortest distance path from the current location of the AV to the AV location and having no obstacles located along the at least one potential travel path.

In an example embodiment, the set distance is equal to zero or the set percentage is equal to zero.

In an example embodiment, the obstacle information is a binary three-dimensional grid comprising a plurality of grid elements each corresponding to a respective volume of the geographic area and each associated with a respective binary value, the respective binary value configured to indicate whether the corresponding respective volume comprises an obstacle.

In an example embodiment, the computer-readable program code portions and/or computer-readable instructions comprise executable portions further configured, when executed by a processor of an apparatus, to cause the apparatus to receive at least one updated position of interest; determine a new preferred AV constellation based on the at least one updated position of interest; determine new respective travel paths from the respective current locations of the set number of AVs to the respective locations of the set number of AVs corresponding to the new preferred AV constellation; and provide new respective instructions for receipt by the respective AVs, the new respective instructions configured to cause the respective AVs to each traverse one of the new respective travel paths.

According to yet another aspect of the present disclosure, an apparatus is provided. In an example embodiment, the apparatus comprises means for generating a first plurality of AV constellations about a geographic area. Each AV constellation comprises a set number of AVs with each AV of the set number of AVs associated with a randomly selected respective location. The first plurality of AV constellations is determined based at least in part on respective current locations of the set number of AVs and obstacle information for the geographic area. Each of the set number of AVs is configured to enable positioning within the geographic area. The apparatus comprises means for determining respective positioning scores for AV constellations of the first plurality of AV constellations. The respective positioning score for an AV constellation of the first plurality of AV constellations is determined based at least in part on a measure of positioning accuracy for at least one position of interest within the geographic area. The apparatus comprises means for generating a second plurality of AV constellations based on the first plurality of AV constellations and the respective positioning scores. The apparatus comprises means for generating an AV constellation of the second plurality of AV constellations by selecting a first AV constellation randomly from the first plurality of AV constellations based on the respective positioning scores for the first plurality of AV constellations, and modifying the first AV constellation by adjusting one or more respective locations of the set number of AVs by respective randomly selected location perturbations. The apparatus comprises means for determining the respective positioning scores for the AV constellations of the second plurality of AV constellations. The apparatus comprises means for selecting a preferred AV constellation from a group of selectable constellations based on the respective positioning score of the preferred AV constellation. The group of selectable constellations is generated based at least in part on one or more of the first plurality of AV constellations or the second plurality of AV constellations.

### BRIEF DESCRIPTION OF THE DRAWINGS

Having thus described certain example embodiments in general terms, reference will hereinafter be made to the accompanying drawings, which are not necessarily drawn to scale, and wherein:

FIG. 1 illustrates an example system of one embodiment of the present disclosure;

FIG. 2A is a block diagram of a network device that may be specifically configured in accordance with an example embodiment;

FIG. 2B is a block diagram of a mobile device that may be specifically configured in accordance with an example embodiment;

FIG. 2C is a block diagram of an aerial vehicle (AV) that may be specifically configured in accordance with an example embodiment;

FIG. 3A is conceptual diagram illustrating an AV constellation configured to enable positioning within a geographic area, in accordance with an example embodiment;

FIG. 3B is a conceptual diagram illustrating the transition of an AV constellation to a (new) preferred AV constellation, in accordance with an example embodiment;

FIG. 4 is a flowchart illustrating operations performed, such as by the network device of FIG. 2A, to determine and/or enact a preferred AV constellation, in accordance with an example embodiment;

FIG. 5 is a flowchart illustrating operations performed, such as by the network device of FIG. 2A, to generate a first plurality of AV constellations, in accordance with an example embodiment;

FIG. 6 is a flowchart illustrating operations performed, such as by the network device of FIG. 2A, to generate a second plurality of AV constellations, in accordance with an example embodiment;

FIG. 7 is a flowchart illustrating operations performed, such as by the network device of FIG. 2A, to generate and/or enact a new preferred AV constellation based on at least one updated position of interest, in accordance with an example embodiment;

FIG. 8 is a flowchart illustrating operations performed, such as by an AV of FIG. 2C, in accordance with an example embodiment;

FIG. 9 is a flowchart illustrating operations performed, such as by the network device of FIG. 2A, to update obstacle information for the geographic area, in accordance with an example embodiment; and

FIG. 10 is a conceptual illustration of a portion of the obstacle information for the geographic area, in accordance with an example embodiment.

### DETAILED DESCRIPTION

Some embodiments will now be described more fully hereinafter with reference to the accompanying drawings, in which some, but not all, embodiments of the invention are shown. Indeed, various embodiments of the invention may be embodied in many different forms and should not be construed as limited to the embodiments set forth herein; rather, these embodiments are provided so that this disclosure will satisfy applicable legal requirements. The term “or” (also denoted “/”) is used herein in both the alternative and conjunctive sense, unless otherwise indicated. The terms “illustrative” and “exemplary” are used to be examples with no indication of quality level. Like reference numerals refer to like elements throughout. As used herein, the terms “data,” “content,” “information,” and similar terms may be used interchangeably to refer to data capable of being transmitted, received and/or stored in accordance with embodiments of the present invention. As used herein, the terms “substantially” and “approximately” refer to values and/or tolerances that are within manufacturing and/or engineering guidelines and/or limits. Thus, use of any such terms should not be taken to limit the spirit and scope of embodiments of the present invention.

Additionally, as used herein, the term ‘circuitry’ refers to (a) hardware-only circuit implementations (e.g., implementations in analog circuitry and/or digital circuitry); (b) combinations of circuits and computer program product(s) comprising software and/or firmware instructions stored on one or more computer readable memories that work together to cause an apparatus to perform one or more functions described herein; and (c) circuits, such as, for example, a microprocessor(s) or a portion of a microprocessor(s), that require software or firmware for operation even if the software or firmware is not physically present. This definition of ‘circuitry’ applies to all uses of this term herein, including in any claims. As a further example, as used herein, the term ‘circuitry’ also includes an implementation comprising one or more processors and/or portion(s) thereof and accompanying software and/or firmware.

### I. General Overview

Various embodiments provide methods, apparatus, systems, and computer program products for determining and/or causing physical enactment of AV constellations configured to enable positioning (e.g., radio-based positioning) within a geographic area. For example, the geographic area may be and/or comprise a building (e.g., a multi-story building) or venue. In various embodiments, the determined AV constellation is configured to provide positioning of maximum and/or at least a threshold accuracy at position(s) of interest within the geographic area (e.g., when an AV is located at each of the AV locations of the AV constellation). In various embodiments, an AV constellation is defined by and/or is a data structure comprising and/or indicating a respective three-dimensional location in and/or near the geographic area for each AV of a set number of AVs (e.g., the number of AVs available for generating the AV constellation). In various embodiments, a preferred AV constellation is determined by randomly generating a first plurality of AV constellations and determining a respective positioning score for each AV constellation of the first plurality of AV constellations. The respective positioning score for an AV constellation characterizes the positioning (e.g., the positioning accuracy) at the position(s) of interest within the geographic area (theoretically) provided by the AV constellation. A second plurality of AV constellations is then generated by perturbing the respective AV locations of one or more AV constellations of the first plurality of AV constellations. For example, an AV constellation of the first plurality of AV constellations is selected using a weighted random selection technique where the weight associated with the AV constellation is determined based at least on the respective positioning score for the AV constellation. Respective positioning scores are determined for the AV constellations of the second plurality of AV constellations.

In various embodiments, the process of generating a second plurality of constellations is iterated. For example, the second plurality of AV constellations may be generated and the respective positioning scores determined therefore. The second plurality of AV constellations and the corresponding respective positioning scores may then be used to generate a third plurality of AV constellations. For example, the second plurality of AV constellations may be used as the first plurality of AV constellations and a new second (or a third) plurality of AV constellations is generated based at least in part on the corresponding respective positioning scores. In various embodiments, the generation of the second plurality of AV constellations is iterated until a convergence requirement is met.

A preferred AV constellation is selected from a group of selectable constellations comprising and/or generated based on the first plurality of AV constellations, the second plurality of AV constellations, and/or a plurality of AV constellations generated based on the second plurality of AV constellations and/or a successor thereof (e.g., third, fourth, and/or the like pluralities of AV constellations). For example, the preferred AV constellation is selected from the group of selectable constellations based on the respective positioning score of the preferred AV constellation, in an example embodiment. For example, the preferred AV constellation is the AV constellation of the group of selectable constellations associated with the respective positioning score indicating the best positioning accuracy at the at least one point of interest, in an example embodiment.

In various embodiments, travel paths for transporting the AVs from respective current locations thereof to the respective three-dimensional locations of the preferred AV constellation are determined. In various embodiments, the travel paths are shortest paths from the respective current locations to the respective three-dimensional locations of the preferred AV constellations. In various embodiments, the travel paths are determined to avoid obstacles in the geographic area based on obstacle information for the geographic area. In various embodiments, respective instructions are generated and provided (e.g., for receipt by the respective AVs) that are configured to cause the AVs to traverse the respective travel paths and/or enable positioning within the geographic area.

In various scenarios, GNSS-based positioning may not be available or may not be available with sufficient accuracy in a geographic area. The geographic area may not have appropriate infrastructure (or the infrastructure may not be available) to enable sufficiently accurate positioning (e.g., radio-based positioning) within the geographic area. For example, the geographic area may be experiencing an emergency situation and it may be desirable to track the position(s) of emergency personnel within the building. In another example, a venue may be holding a short term event and it may be desirable to enable positioning of device(s) (e.g., mobile devices associated with participants of the event) during the event. In another example, a warehouse or facility may have a number of assets and personnel located therein and it may be desirable to track the location of the assets and/or personnel during a power outage or other situation. Therefore, it may be desirable to temporarily enable positioning within the geographic area.

One method for temporarily enabling positioning with the geographic area is to dispatch a number of AVs to set locations in and/or near the geographic area. The AVs may emit and/or broadcast radio frequency, for example, signals. One or more devices (e.g., mobile devices) in the geographic area may receive and/or observe the signals emitted and/or broadcasted by at least one of the AVs and, based on characteristics of the received and/or observed signals, determine a position of the device (or request a position of the device be determined by a Cloud-based service, for example). However, a technical problem exists regarding how to best position the AVs in and/or proximate the geographic area to enable sufficiently accurate positioning and service availability. For example, it may be desired to have the maximum amount of positioning accuracy and/or at least a threshold amount of positioning accuracy at the position(s) of interest (e.g., the position(s) of a mobile device(s) worn or carried by respective emergency personnel, position(s) where the infrastructure within the geographic area does not provide positioning of sufficient accuracy, and/or the like). Technical problems therefore exists as to how to generate a physical AV constellation that provides sufficient and/or desired positioning accuracy at position(s) of interest, how to update the AV constellation when at least one position of interest changes and/or moves, and how to deal with obstacles located within and/or proximate the geographic area while enacting the physical AV constellation.

Various embodiments provide technical solutions to these technical problems. For example, various embodiments generate a preferred AV constellation that provides the best and/or sufficient positioning accuracy at position(s) of interest given the number of AVs available for forming the physical AV constellation. Various embodiments further provide methods for causing the physical enactment of the preferred AV constellation and/or causing the AVs to form the physical AV constellation at the geographic area. Various embodiments further generate new preferred AV constellations when at least one position of interest moves and/or changes. For example, a new preferred AV constellation is generated in (near) real-time with respect to the receipt of at least one updated position of interest and based on the at least one updated position of interest, in an example embodiment. The AVs are then caused to adjust their respective locations in accordance with the new preferred AV constellation in (near) real-time, in an example embodiment. Therefore, various embodiments provide technical advantages to the fields of positioning and temporarily enabling positioning in a geographic area.

### II. Example System(s)

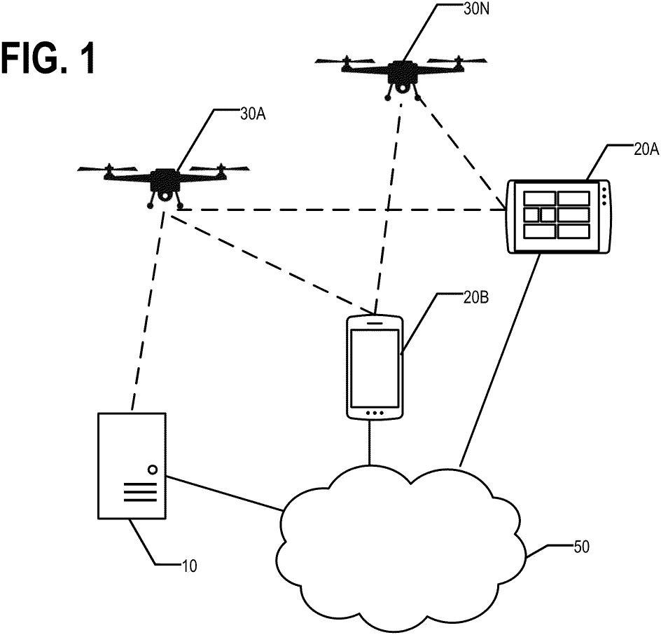

FIG. 1 provides an illustration of an example system that can be used in conjunction with various embodiments of the present invention. As shown in FIG. 1, the system may include one or more network devices 10, one or more mobile devices 20, one or more AVs 30, one or more networks 50, and/or the like. In various embodiments, an AV 30 may be an unmanned, autonomous, semi-autonomous, and/or other aerial vehicle. In various embodiments, the AV 30 comprises one or more sensors configured to enable the AV 30 to determine a three-dimensional location of the AV 30. In various embodiments, the AV 30 further comprises one or more sensors, radio interfaces, and/or the like, configured to emit and/or broadcast radio frequency signals configured to enable positioning of a mobile device 20 located within the geographic area. In an example embodiment, the AV 30 comprises one or more sensors, radio interfaces, and/or the like, configured to receive and/or observe radio frequency signals generated and/or transmitted by a mobile device 20 located within the geographic area.

In various embodiments, the mobile device 20 is within the geographic area and is configured to receive and/or observe radio frequency signals and determine or request determination of a position of the mobile device 20 based on the received and/or observed radio frequency signals. In various embodiments, the mobile device 20 is configured to provide the position of the mobile device 20 (e.g., for receipt by a network device 10). In various embodiments, a computing device 20 may be a user device, mobile device, and/or other computing entity that may be used to perform one or more positioning and/or navigation-related functions, such as displaying an indoor and/or outdoor route guidance user interface, and/or the like.

In various embodiments, the network device 10 is configured to generate a preferred AV constellation configured to enable positioning with maximum positioning accuracy and/or at least a threshold positioning accuracy at position(s) of interest within the geographic area based on the position(s) of interest and information regarding the geographic area and obstacles in the proximity thereof. In various embodiments, the network device 10 is configured to cause the AVs to adjust their respective locations in accordance with the preferred AV constellation, generate a new preferred AV constellation based on at least one updated position of interest, and/or the like. In an example embodiment, the network device 10 is a server, group of servers, Cloud-based service, and/or the like.

In various embodiments, the network device 10 may be in direct communication with one or more AVs 30 and/or one or more mobile devices 20 via a wireless communication protocol. For example, the wireless communication protocol may be a 5G protocol, short range 5G protocol, peer-to-peer 5G protocol, cellular communications, wi-fi communications, and/or the like. In an example embodiment, network device 10 may be in communication with one or more mobile devices 20, one or more AVs 30, and/or the like via one or more wired and/or wireless networks 50.

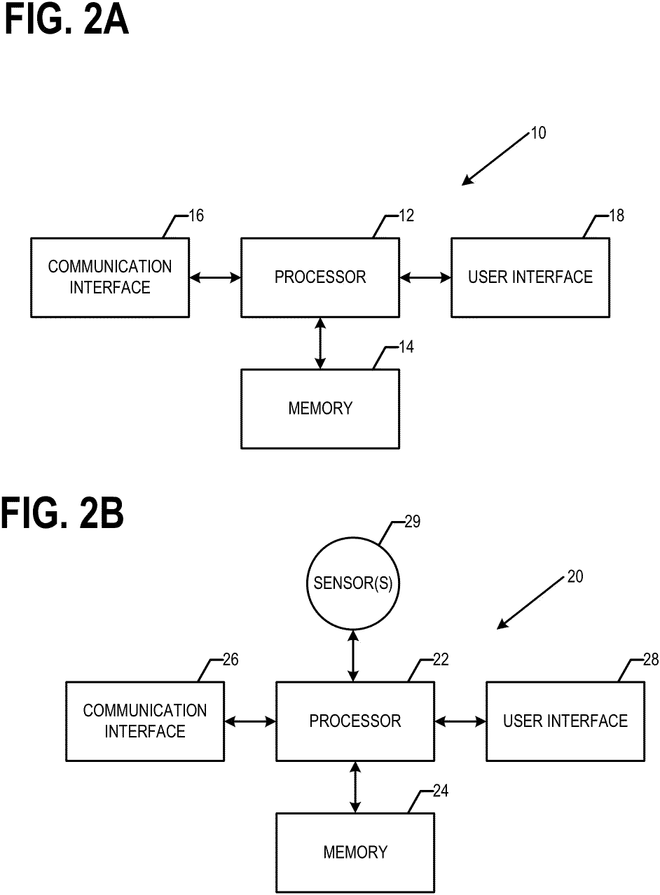

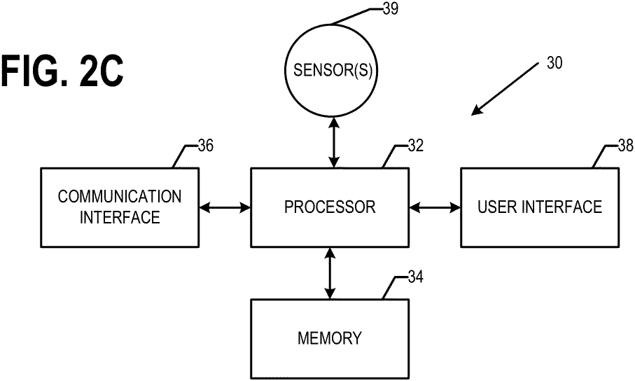

In an example embodiment, a network device 10 may comprise components similar to those shown in the example network device 10 diagrammed in FIG. 2A. In an example embodiment, the network device 10 is configured to obtain and/or receive position(s) of interest in a geographic and obstacle information for the geographic area; generate a preferred AV constellation; cause the AVs to adjust their respective locations based on the preferred AV constellation; generate a new preferred AV constellation based on at least one updated position of interest within the geographic area; and/or the like.

For example, as shown in FIG. 2A, the network device 10 may comprise a processor 12, memory 14, a user interface 18, a communications interface 16, and/or other components configured to perform various operations, procedures, functions or the like described herein. In various embodiments, the network device 10 stores obstacle information corresponding to the geographic area, libraries for generating instructions for causing an AV to adjust its location, and/or the like (e.g., in memory 14). In at least some example embodiments, the memory 14 is non-transitory.

In an example embodiment, a mobile device 20 is a user computing device, mobile computing device, and/or other computing device configured to perform one or more positioning and/or navigation-related functions, such as determining and/or providing a position of the mobile device, generating and/or providing (e.g., via a user interface) a route at least partially within the geographic area, displaying a route guidance user interface, and/or the like. In an example embodiment, the mobile device 20 is configured to receive and/or observe radio frequency signals and perform positioning based on the received and/or observed radio frequency signals. In an example embodiment, as shown in FIG. 2B, the mobile device 20 may comprise a processor 22, memory 24, a communications interface 26, a user interface 28, one or more sensors 29 and/or other components configured to perform various operations, procedures, functions or the like described herein. In various embodiments, the mobile device 20 stores at least a portion of one or more digital maps (e.g., geographic databases, positioning maps, and/or the like), computer-executable instructions for performing positioning based on received and/or observed radio frequency signals, and/or the like in memory 24. In at least some example embodiments, the memory 24 is non-transitory.

In various embodiments, the sensors 29 comprise one or more location sensors such as a GNSS sensor, inertial measurement unit (IMU) sensors (e.g., accelerometers, gyroscopes, magnetometers, and/or the like), altimeters, barometers, and/or the like. In various embodiments, the sensors 29 comprise one or more image sensors configured to capture visual samples, such as digital camera(s), 3D cameras, 360° cameras, and/or image sensors. In various embodiments, the one or more sensors 29 may comprise one or more interfaces, such as radio interfaces, configured to observe and/or receive signals generated and/or transmitted by one or more network access points, AVs 30, and/or the like. For example, the one or more interfaces may be configured (possibly in coordination with processor 22) to determine an AV identifier configured to identify the AV 30 that emitted and/or broadcast a signal observed by the computing device 20, extract an AV location indicating the three-dimensional location of the AV 30 that emitted and/or broadcast the signal received and/or observed by the mobile device 20 from the signal, determine a signal strength of the signal observed by the mobile device 20, a one way or round trip time value for a signal observed by the mobile device 20, and/or the like. As used herein, when a mobile device 20 observes an AV 30, the mobile device 20 has observed a signal emitted and/or broadcast by the AV 30. In an example embodiment, the interface may be configured to observe one or more types of signals such as generated and/or transmitted in accordance with one or more protocols such as 5G, general packet radio service (GPRS), Universal Mobile Telecommunications System (UMTS), Code Division Multiple Access 2000 (CDMA2000), CDMA2000 1X (1xRTT), Wideband Code Division Multiple Access (WCDMA), Global System for Mobile Communications (GSM), Enhanced Data rates for GSM Evolution (EDGE), Time Division-Synchronous Code Division Multiple Access (TD-SCDMA), Long Term Evolution (LTE), Evolved Universal Terrestrial Radio Access Network (E-UTRAN), Evolution-Data Optimized (EVDO), High Speed Packet Access (HSPA), High-Speed Downlink Packet Access (HSDPA), IEEE 802.11 (Wi-Fi), Wi-Fi Direct, 802.16 (WiMAX), ultra-wideband (UWB), infrared (IR) protocols, near field communication (NFC) protocols, Wibree, Bluetooth protocols, wireless universal serial bus (USB) protocols, and/or any other wireless protocol. For example, the interface may be configured to observe signals of one or more modern global cellular formats such as GSM, WCDMA, TD-SCDMA, LTE, LTE-A, CDMA, NB-IoT and/or non-cellular formats such as WLAN, Bluetooth, Bluetooth Low Energy (BLE), Zigbee, Lora, and/or the like. For example, the interface may be configured to observe radio, millimeter, microwave, and/or infrared wavelength signals. In an example embodiment, the interface may be coupled to and/or part of a communications interface 26. In various embodiments, the sensors 29 may comprise various other sensors such as two dimensional (2D) and/or three dimensional (3D) light detection and ranging (LiDAR)(s), long, medium, and/or short range radio detection and ranging (RADAR), ultrasonic sensors, electromagnetic sensors, (near-) infrared (IR) cameras.

In an example embodiment, an AV 30 is an unmanned, autonomous, semi-autonomous, and/or other aerial vehicle. For example, the AV 30 may be a drone, in an example embodiment. In an example embodiment, the AV 30 is configured to enable positioning within the geographic. For example, in an example embodiment, the AV 30 is configured to maintain a respective location indicated by the preferred AV constellation (and update the respective location in accordance with a new preferred AV constellation) and emit and/or broadcast radio frequency signals. In an example embodiment, the radio frequency signals emitted and/or broadcasted by the AV 30 comprise an AV identifier configured to identify the AV 30 and/or an indication of the three-dimensional location of the AV 30 (e.g., latitude, longitude, and altitude/elevation/height; or local/relational coordinates). In an example embodiment, as shown in FIG. 2C, the AV 30 may comprise a processor 32, memory 34, a communications interface 36, a user interface 38, one or more sensors 39 and/or other components configured to perform various operations, procedures, functions or the like described herein. In various embodiments, the AV 30 stores at least a portion of one or more digital maps (e.g., geographic databases, positioning maps, and/or the like) and/or computer executable instructions for determining a three-dimensional location of the AV based on sensor data captured by one or more sensors 39, emitting and/or broadcasting radio frequency signals, and/or the like in memory 34. In at least some example embodiments, the memory 34 is non-transitory. The AV 30 may further comprise various components for controlling the AV 30, causing the AV 30 to fly along a travel path, cause the AV 30 use sensors 39 to identify obstacles in the vicinity of the AV 30 and/or in or proximate the geographic area, and/or the like. For example, the AV 30 may comprise one or more flying systems and/or vehicle control and/or routing systems and corresponding executable instructions may be stored in memory 34.

In various embodiments, the sensors 39 comprise one or more location sensors such as a GNSS sensor, inertial measurement unit (IMU) sensors (e.g., accelerometers, gyroscopes, magnetometers, and/or the like), altimeters, and/or the like. In various embodiments, the sensors 39 comprise one or more image sensors configured to capture visual samples, such as digital camera(s), 3D cameras, 360° cameras, and/or image sensors. In various embodiments, the one or more sensors 39 may comprise one or more interfaces, such as radio interfaces, configured to emit and/or broadcast signals and/or observe and/or receive signals generated and/or transmitted by one or more computing entities (e.g., mobile device 20). For example, the one or more interfaces may be configured (possibly in coordination with processor 32) to determine a mobile device identifier configured to identify the mobile device 20 that generated and/or transmitted a signal observed by the AV 30, a signal strength of the signal observed by the AV 30, a one way or round trip time value for a signal observed by the AV 30, and/or the like. As used herein, when an AV 30 observes a mobile device 20, the AV 30 has observed a signal generated and/or transmitted by the mobile device 20. In an example embodiment, the interface may be configured to observe one or more types of signals such as generated and/or transmitted in accordance with one or more protocols such as 5G, general packet radio service (GPRS), Universal Mobile Telecommunications System (UMTS), Code Division Multiple Access 2000 (CDMA2000), CDMA2000 1X (1xRTT), Wideband Code Division Multiple Access (WCDMA), Global System for Mobile Communications (GSM), Enhanced Data rates for GSM Evolution (EDGE), Time Division-Synchronous Code Division Multiple Access (TD-SCDMA), Long Term Evolution (LTE), Evolved Universal Terrestrial Radio Access Network (E-UTRAN), Evolution-Data Optimized (EVDO), High Speed Packet Access (HSPA), High-Speed Downlink Packet Access (HSDPA), IEEE 802.11 (Wi-Fi), Wi-Fi Direct, 802.16 (WiMAX), ultra-wideband (UWB), infrared (IR) protocols, near field communication (NFC) protocols, Wibree, Bluetooth protocols, wireless universal serial bus (USB) protocols, and/or any other wireless protocol. For example, the interface may be configured to observe signals of one or more modern global cellular formats such as GSM, WCDMA, TD-SCDMA, LTE, LTE-A, CDMA, NB-IoT and/or non-cellular formats such as WLAN, Bluetooth, Bluetooth Low Energy (BLE), Zigbee, Lora, and/or the like. For example, the interface may be configured to observe radio, millimeter, microwave, and/or infrared wavelength signals. In an example embodiment, the interface may be coupled to and/or part of a communications interface 36. In various embodiments, the sensors 39 may comprise various other sensors such as two dimensional (2D) and/or three dimensional (3D) light detection and ranging (LiDAR)(s), long, medium, and/or short range radio detection and ranging (RADAR), ultrasonic sensors, electromagnetic sensors, (near-) infrared (IR) cameras.

Each of the components of the system may be in electronic communication with, for example, one another over the same or different wireless or wired networks 50 including, for example, a wired or wireless Personal Area Network (PAN), Local Area Network (LAN), Metropolitan Area Network (MAN), Wide Area Network (WAN), cellular network, and/or the like. In an example embodiment, a network 50 comprises the automotive cloud, digital transportation infrastructure (DTI), radio data system (RDS)/ high definition (HD) radio or other digital radio system, and/or the like. For example, a mobile device 20 and/or AV 30 may be in communication with a network device 10 via the network 50. For example, a mobile device 20 and/or AV 30 may communicate with the network device 10 via a network, such as the Cloud. In an example embodiment, the mobile device 20 and/or AV 30 may access a network, such as the Cloud, via the network device 10. For example, the Cloud may be a computer network that provides shared computer processing resources and data to computers and other devices connected thereto. For example, the mobile device 20 and/or AV 30 may be configured to provide a position or location thereof, and/or the like via the network 50. For example, the network device 10 may be configured to receive positions of one or more mobile devices 20 and/or locations of one or more AVs 30 and/or provide instructions for adjusting respective locations of AVs 30 based on a preferred AV constellation via the network 50.

Certain example embodiments of the network device 10, mobile device 20, and AV 30 are described in more detail below with respect to FIGS. 2A, 2B, and 2C.

### II. Example Operation(s)

In various scenarios, such as within an urban canyon or an indoor environment, a mobile device 20 may not be able to rely on GNSS-based positioning techniques. In such scenarios, the mobile device 20 may attempt to use radio-based positioning. In radio-based positioning, a device (e.g., the mobile device 20) observes radio signals emitted and/or broadcasted by various radio nodes located in the proximity of the device. Based on the observed radio signals and a radio map describing the expected radio environment in a geographic region expected to include the position the device, the device (or a remote server or Cloud-based service) determines a position estimate for the position of the device (e.g., using triangulation, received signal strength and/or one way or round trip time signal propagation time, and/or the like).

However, to perform radio-based positioning, there must be radio nodes (e.g., network access points and/or other radio signal emitting devices) that emit and/or broadcast radio signals that are observable to the device for which the positioning is being performed. In some situations, a geographic area has an infrastructure including a plurality of radio nodes (e.g., Wi-Fi, cellular, and/or other network access points, dedicated positioning radio nodes, and/or the like) and this infrastructure may be used to provide the radio signals that are observable to the device for performing radio-based positioning. However, in various situations, the geographic area may not include such infrastructure and/or such infrastructure may not be available (e.g., during a power outage or emergency situation). In another example, the infrastructure may not be known well enough (e.g., the location of the radio nodes, transmission patterns and/or strengths of the radio nodes, and/or the like) to provide sufficient positioning accuracy.

Various embodiments provide technical solutions to such technical problems by generating preferred AV constellations that (at least temporarily) enable positioning (e.g., radio-based positioning) at position(s) of interest within a geographic area. Various embodiments cause a set of AVs 30 to enact and/or form the generated preferred AV constellation. In various embodiments, the preferred AV constellation is a data structure that comprises and/or indicates AV locations for a set number of AVs 30. For example, the set number of AVs is the number of AVs 30 available for forming the physical AV constellation, in an example embodiment. For example, when N AVs 30 are available for forming the physical AV constellation, the preferred AV constellation comprises M AV locations, where M ≤ N.

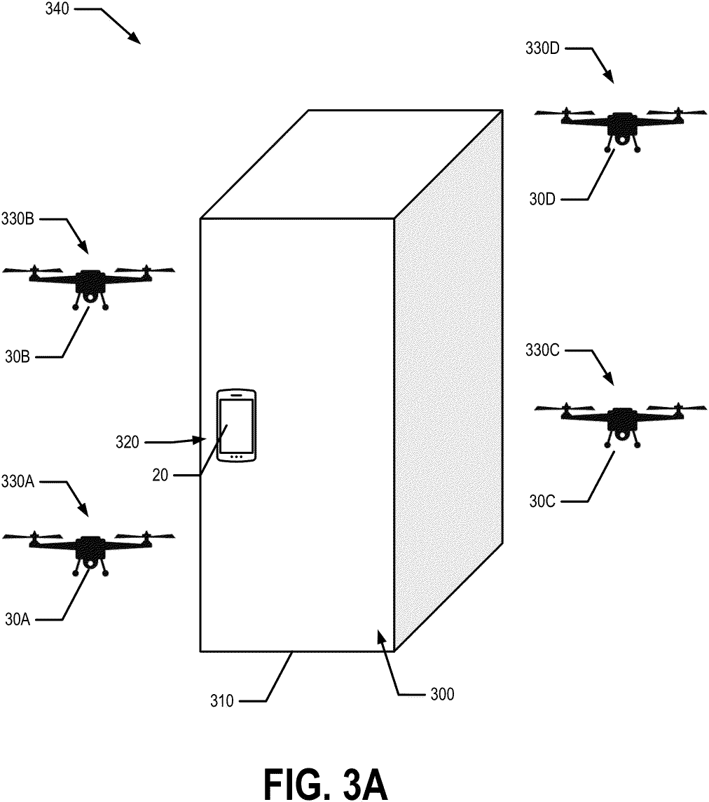

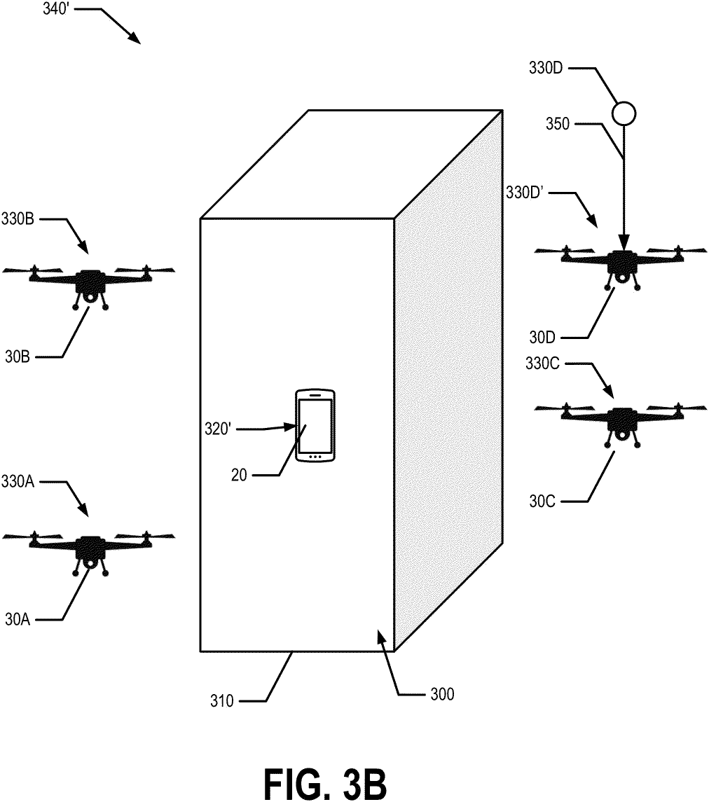

FIG. 3A illustrates a geographic area 300 comprising a building 310 at a time t₁. The building 310 includes at least two floors, stories, or levels. The physical AV constellation 340 comprises four AV locations 330A, 330B, 330C, 330D in and/or around the geographic area 300. As illustrated, the AVs 30A, 30B, 30C, 30D are respectively located at the AV locations 330A, 330B, 330C, 330D to form the physical AV constellation. At least one position of interest 320 is located within the geographic area 300. In the illustrated scenario, a mobile device 20 is located at the at least one position of interest 320. As should be understood, a plurality of positions of interest may be located within the geographic area 300 and one or more mobile devices 20 may be respectively located at one or more of the plurality of positions of interest 320. For example, a plurality of emergency personnel (e.g., firefighters, etc.) may each carry and/or wear a respective mobile device while responding to an emergency situation at the geographic area. Thus, a plurality of mobile devices (with each mobile device physically associated with a respective firefighter, emergency medical provider, and/or the like) are located within the geographic space and the position of each mobile device of the plurality of mobile devices is considered a position of interest, in an example embodiment.

FIG. 3B illustrates the geographic area 300 at a time t₂ after time t₁. The mobile device 20 has moved to an updated position of interest 320'. Responsive thereto, a new preferred AV constellation has been determined and the physical AV constellation 340' illustrates the physical enactment of the new preferred constellation. For example, the AV 30D has moved from a previous AV location 330D to a new AV location 330D', by traversing travel path 350. As should be understood, in the new preferred AV constellation, one or more of the AV locations may be different and/or have changed from the previous preferred AV constellation.

While the AVs 30 are located at the AV locations 330, they may each emit and/or broadcast radio signals that may be observable by mobile device(s) 20 located within the geographic area 300. As the AV locations 330 are known, observation of the radio signals emitted by the AVs 30 by a mobile device 20 can be used to determine a position estimate for the mobile device 20 with sufficient positioning accuracy.

For example, in various embodiments, a mobile device 20 located within the geographic area 300 observes one or more radio signals emitted and/or broadcasted by one or more AVs 30. For example, the mobile device 20 comprises means, such as processor 22, memory 24, communication interface 26, sensors 29, and/or the like for observing one or more radio signals emitted and/or broadcasted by one or more AVs 30. For example, the mobile device 20 may extract various signal parameters from the observed radio signals, including but not limited to, an AV identifier configured to identify the AV 30 that emitted and/or broadcasted the radio signal, an AV location 330 of the AV 30 that emitted and/or broadcasted the radio signal, a received signal strength, a timing parameter (e.g., one way or round trip time) corresponding to the propagation of the radio signal, and/or the like.

For example, in various embodiments, the mobile device 20 is configured to generate a position estimate based on the observed radio signals and/or signal parameters extracted therefrom. For example, the mobile device 20 comprises means, such as the processor 22, memory 24, and/or the like, for generating a position estimate for the position of the mobile device 20 based on the observed radio signals and/or signal parameters extracted therefrom. In an example embodiment, the mobile device 20 is configured to provide the position estimate (such as for receipt by the network device 10). For example, the mobile device 20 comprises means, such as processor 22, memory 24, communication interface 26, and/or the like, for providing the position estimate.

For example, in various embodiments, the mobile device 20 is configured to provide the signal parameters extracted from the observed radio signals such that another computing entity (e.g., network device 10, a Cloud-based positioning service, and/or the like) can determine the position estimate for the position of the mobile device 20. For example, the mobile device 20 comprises means, such as processor 22, memory 24, communications interface 26, and/or the like for providing the signal parameters extracted from the observed radio signals such that another computing entity (e.g., network device 10, a Cloud-based positioning service, and/or the like) can determine the position estimate for the position of the mobile device 20.

The network device 10 is configured to receive as input the at least one position of interest 320, information regarding the geometry and/or topology of the building 310 and/or obstacle information for the geographic area 300, and the number of available AVs 30, in various embodiments. The network device 10 is configured to determine a preferred AV constellation comprising the AV locations 330. In an example embodiment, the network device 10 is further configured to determine respective travel paths from the current locations of the AVs 30 to the respective new locations of the AVs 30 of the preferred AV constellation, to generate and provide respective instructions configured to cause the AVs 30 to traverse the respective travel paths, and/or the like.

In various embodiments, an AV 30 is configured to received instructions configured to cause the AV 30 to traverse a travel path 350. The AV 30 is configured to traverse the travel path 350 based on the received instructions and to maintain itself at the respective AV location 330. The AV 30 is further configured to enable positioning within the geographic area 300 while the AV 30 is located at the AV location 330. For example, in an example embodiment, the AV 30 is configured to emit and/or broadcast radio signals that are observable by mobile devices 20 located within the geographic area 300 to enable positioning of the mobile devices 20. In various embodiments, the AV 30 is further configured to use one or more sensors 39 (e.g., GNSS sensors, visual sensors, radio interfaces, RADAR, LiDAR, and/or the like) to monitor the location of the AV 30, identify obstacles and/or locations of obstacles in the proximity of the AV 30, and/or the like.

### A. Example Operation of a Network Device to Generate a Preferred AV Constellation

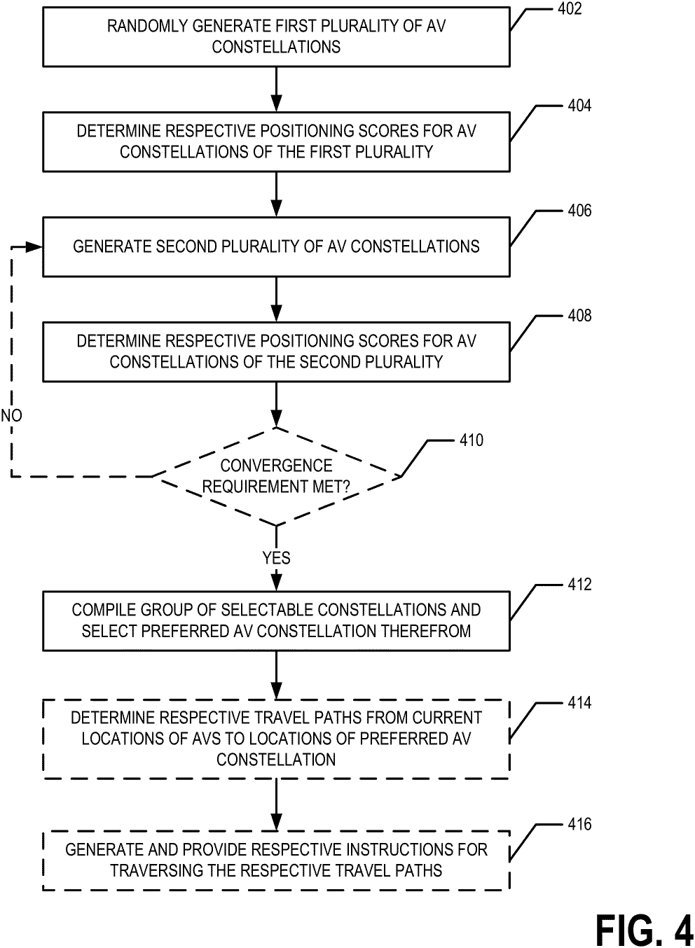

In various embodiments, the network device 10 is configured to receive as input the at least one position of interest 320, information regarding the geometry and/or topology of the building 310 and/or obstacle information for the geographic area 300, and the number of available AVs 30, in various embodiments. Based on these inputs, the network device 10 is configured to determine a preferred AV constellation comprising the AV locations 330. FIG. 4 provides a flowchart illustrating various processes, procedures, operations, and/or the like performed by a network device 10, in various embodiments, for generating, and optionally enacting, a preferred AV constellation.

Starting at block 402, the network device 10 generates a first plurality of AV constellations. For example, the network device 10 comprises means, such as processor 12, memory 14, and/or the like, for generating a first plurality of AV constellations. In various embodiments, an AV constellation is a data structure comprising a set number of AV locations (three-dimensional locations) in and/or around the geographic area. In various embodiments, the set number of AV locations corresponds to the number of AVs 30 available for forming the physical AV constellation. In various embodiments, the first plurality of AV constellations comprises a first specified quantity of AV constellations. In various embodiments, the first specified quantity is tens of AV constellations, hundreds of AV constellations, thousands of AV constellations, or tens of thousands of AV constellations. For example, in an example embodiment, the first specified quantity is 1000 AV constellations.

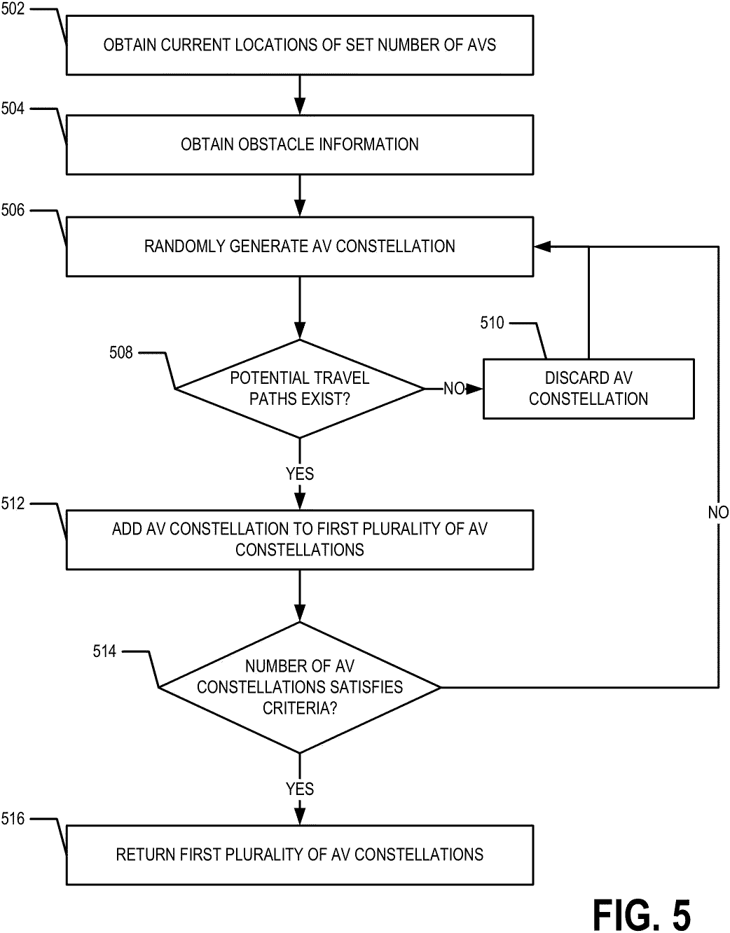

In various embodiments, the AV constellations of the first plurality of AV constellations are generated randomly. For example, the set number of AV locations of an AV constellation are selected at random (e.g., using a random number generator, using a technique or engine for randomly selecting a position in and/or about the geographic area, and/or the like). In an example embodiment, the first plurality of AV constellations is determined at least in part based on the respective current locations of the AVs (e.g., at a not yet deployed on the ground location, at a deployed location in the geographic area, and/or the like). For example, as described in more detail with respect to FIG. 5, in various embodiments, an AV constellation is generated by randomly generating the AV locations of the AV constellation and then a determination is made (e.g., based on the current location of the respective AVs and/or obstacle information for the geographic area) whether or not to include the AV constellation in the first plurality of AV constellations. For example, the first plurality of AV constellations may be randomly generated and filtered based at least in part on the current locations of the AVs and/or obstacle information for the geographic area.

At block 404, the network device 10 determines respective positioning scores for AV constellations of the first plurality of AV constellations. For example, the network device 10 comprises means, such as processor 12, memory 14, and/or the like, for determining respective positioning scores for AV constellations of the first plurality of AV constellations. In an example embodiment, a respective positioning score is determined for each AV constellation of the first plurality of AV constellations. In various embodiments, the respective positioning score for an AV constellation characterizes the positioning (e.g., the positioning accuracy) at the position(s) of interest within the geographic area that is (theoretically) enabled by the AV constellation.

For example, in various embodiments, the respective positioning scores are determined based at least in part on a measure of positioning accuracy for the position(s) of interest within the geographic area. In an example embodiment, the measure of positioning accuracy is the diameter of a particular confidence interval or sphere (e.g., the diameter of one sigma sphere, 1.5 sigma sphere, two sigma sphere, and/or the like). In an example embodiment, the measure of positioning accuracy is the confidence level of a sphere of a particular diameter (e.g., one meter diameter, two meter diameter, three meter diameter, and/or the like). In an example embodiment, the measure of positioning accuracy is a (aggregated) geometric dilution of precision (GDOP) value for the position(s) of interest corresponding to the positioning enabled by the AV constellation. In various embodiments, one or more other dilution of precision (e.g., horizontal dilution of precision (HDOP), vertical dilution of precision (VDOP), position (three-dimensional) dilution of precision (PDOP), time dilution of precision (TDOP), and/or the like) values corresponding to the position(s) of interest may be used alone and/or in combination (with the GDOP value and/or one or more other dilution of precision values) for determining the measure of positioning accuracy.

In various embodiments, there are two or more positions of interest. In such embodiments, a respective measure of positioning accuracy is determined for each of the two or more positions of interest. The positioning score is then determined based on one or more of the respective measures of positioning accuracy and/or an aggregation of the respective measures of positioning accuracy for the two or more positions of interest. For example, the positioning score may be determined based on the average (e.g., mean, median, or mode) of the respective measures of positioning accuracy, the respective measure of positioning accuracy indicating the least accurate positioning satisfying a threshold criteria, and/or a combination thereof. In an example embodiment, the positioning score for an AV constellation is determined based at least in part on a weighted average of the respective measures of positioning accuracy for the positions of interest, where respective positions of interest are assigned weights based on various factors. For example, the various factors may include one or more of characteristics, capabilities, and/or specification information of a respective mobile device corresponding to the respective position of interest; mobile device demand for positioning services (e.g., number of requests, frequency of requests, and/or the like); environmental factors; proximity of the position of interest to a position of concern (e.g., a location of an emergency situation within the geographic area, and/or the like); and/or the like. For example, in an example embodiment, the positioning score for an AV constellation is and/or is determined based at least in part on the (weighted) average GDOP for the position(s) of interest. For example, the positions of interest may correspond to a plurality of mobile devices each carried and/or worn by a respective member of emergency personnel responding to an emergency at the geographic area with one member of the emergency personnel (and the associated mobile device) located on a same floor as the emergency situation and the other emergency personnel (and their associated mobile devices) located on various other floors within the geographic area. The position of interest corresponding to the position of the mobile device that is located on the same floor as the emergency situation may be assigned a heavier weight than the other positions of interest which are located further from the emergency situation.

In an example embodiment, a respective positioning score for an AV constellation is based on a combination of criteria. For example, the respective positioning score for an AV constellation may be determined based on (a) a determine of whether the least accurate positioning enabled at a position interest of the position(s) of interest satisfies a threshold criteria and (b) an (weighted) average of the respective measures of positioning accuracy for the positions of interest. For example, the respective positioning score may be determined based on (a) determining that the lowest GDOP value for positions of interest satisfies a GDOP threshold value and (b) an (weighted) average GDOP value for the positions of interest.

In various embodiments, a position of interest is a particular location within the geographic area. For example, one of the position(s) of interest may be located at or near a point of interest (POI) such as a particular vendor, water fountain, article of interest, restrooms, information desk, kiosk, registration desk, and/or the like. For example, a position of interest may be a location within the geographic area where the existing infrastructure is known to not enable sufficiently accurate positioning. In an example embodiment, a position of interest is a particular point or location. In an example embodiment, the position of interest is a defined volume (e.g., the volume of a room, group of rooms, floor, elevator, elevator shaft, and/or the like).

In various embodiments, a position of interest is the position of a mobile device 20 within the geographic area. For example, the mobile device 20 may be carried by, associated with, and/or worn by an emergency service personnel, event participant, and/or the like. In an example embodiment, the mobile device 20 is carried by and/or is part of a robot, such as a robotic search and rescue personnel. In an example embodiment wherein the position(s) of interest includes two or more positions of interest (e.g., a plurality of positions of interest), the two or more positions of interest may respectively be one or more particular locations within the geographic area, one or more positions of mobile devices 20 within the geographic area, and/or a combination thereof (e.g., at least one of the two or more positions of interest may be a particular (e.g., set) location and at least one of the two or more positions of interest may be the position of a mobile device 20).

In an example embodiment, the one or more mobiles devices 20 are tracking devices physically associated with respective members of personnel and/or assets and the geographic area comprises a warehouse or other facility comprising trackable assets/items and an AV constellation may be used to track the location of the personnel and/or trackable assets/items during a power outage or other situation.

At block 406, the network device 10 determines and/or generates a second plurality of AV constellations. For example, the network device 10 comprises means, such as processor 12, memory 14, and/or the like, for determining and/or generating a second plurality of AV constellations. Similar to the AV constellations of the first plurality of AV constellations, in various embodiments, an AV constellation of the second plurality of AV constellations is a data structure comprising a set number of AV locations (three-dimensional locations) in and/or around the geographic area. In various embodiments, the set number of AV locations corresponds to the number of AVs 30 available for forming the physical AV constellation. In various embodiments, the second plurality of AV constellations comprises a second specified quantity of AV constellations. In various embodiments, the second specified quantity is tens of AV constellations, hundreds of AV constellations, thousands of AV constellations, or tens of thousands of AV constellations. For example, in an example embodiment, the second specified quantity is 1000 AV constellations.

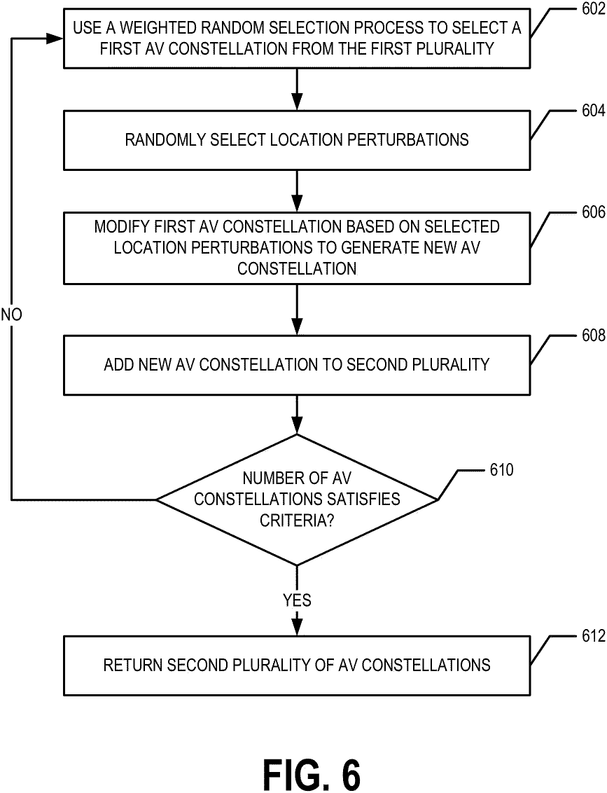

In various embodiments, the second plurality of AV constellations are determined and/or generated based at least in part on one or more AV constellations of the first plurality of AV constellations and the corresponding respective positioning scores. For example, in an example embodiment, the second plurality of AV constellations is determined and/or generated by applying respective location perturbations to the AV locations of one or more AV constellations of the first plurality of AV constellations. In various embodiments, the one or more AV constellations are selected from the first plurality of AV constellations based on the respective positioning scores. For example, the one or more AV constellations selected from the first plurality of AV constellations may be the one or more AV constellations of the first plurality of AV constellations that are associated with the respective positioning scores indicating the most accurate positioning (e.g., the 99^{th} percentile, 95^{th} percentile, 90^{th} percentile, 80^{th} percentile, 75^{th} percentile, 70^{th} percentile, and/or the like). In various embodiments, the one or more AV constellations are selected randomly from the first plurality of AV constellations based on a weight associated therewith corresponding to the respective positioning score, as described in more detail with respect to FIG. 6.

In various embodiments, the respective location perturbations applied to one or more AV locations of a selected AV constellation are selected at random from a defined range (e.g., a distance of up to a quarter of a meter, up to half a meter, up to one meter, up to two meters, up to five meters, and/or the like). For example, the AV location of an AV constellation of the second plurality of AV constellations is within a defined volume about an AV location of the corresponding/selected AV constellation of the first plurality of AV constellations.

At block 408, the network device 10 determines respective positioning scores for AV constellations of the second plurality of AV constellations. For example, the network device 10 comprises means, such as processor 12, memory 14, and/or the like, for determining respective positioning scores for AV constellations of the second plurality of AV constellations. In an example embodiment, a respective positioning score is determined for each AV constellation of the second plurality of AV constellations. In various embodiments, the respective positioning score for an AV constellation characterizes the positioning (e.g., the positioning accuracy) at position(s) of interest within the geographic area that is (theoretically) enabled by the AV constellation.

For example, in various embodiments, the respective positioning scores are determined based at least in part on a measure of positioning accuracy for the position(s) of interest within the geographic area. In an example embodiment, the measure of positioning accuracy is the diameter of a particular confidence interval or sphere (e.g., the diameter of one sigma sphere, 1.5 sigma sphere, two sigma sphere, and/or the like). In an example embodiment, the measure of positioning accuracy is the confidence level of a sphere of a particular diameter (e.g., one meter diameter, two meter diameter, three meter diameter, and/or the like). In an example embodiment, the measure of positioning accuracy is a GDOP value for the position(s) of interest corresponding to the positioning enabled by the AV constellation. In various embodiments, one or more other dilution of precision (HDOP, VDOP, PDOP, TDOP, and/or the like) values corresponding to the position(s) of interest may be used alone and/or in combination (with the GDOP value and/or one or more other dilution of precision values) as the measure of positioning accuracy.

In various embodiments, there are two or more positions of interest. In such embodiments, a respective measure of positioning accuracy for an AV constellation of the second plurality of AV constellations is determined for each of the two or more positions of interest. The positioning score for the AV constellation of the second plurality of AV constellations is then determined based on one or more of the respective measures of positioning accuracy and/or an aggregation of the respective measures of positioning accuracy for the two or more positions of interest. For example, the positioning score may be determined based on the average (e.g., mean, median, or mode) of the respective measures of positioning accuracy, the respective measure of positioning accuracy indicating the least accurate positioning enabled at a position of interest by the AV constellation satisfies a threshold criteria, and/or a combination thereof. For example, the respective positioning score for an AV constellation may comprise an indication of whether the respective measure of positioning accuracy indicating the least accurate positioning enabled at a position of interest of the two or more positions of interest satisfies a threshold criteria and an average of the respective measures of positioning accuracy for the positioning enabled at each of the two or more positions of interest.

In various embodiments, the steps of generating a second plurality of AV constellations and determining the respective positioning scores for the AV constellations of the second plurality of AV constellations may be iterated and/or repeated until a convergence criteria is met. For example, the second plurality of AV constellations and the respective positioning scores associated therewith are used to generate a third plurality of AV constellations, in various embodiments. For example, the second plurality of AV constellations (and the respective positioning scores associated therewith) may be used in a manner similar to that described with respect to the fist plurality of AV constellations to generate a third plurality of AV constellations.

For example, in various embodiments, the third plurality of AV constellations are determined and/or generated based at least in part on one or more AV constellations of the second plurality of AV constellations and the corresponding respective positioning scores. For example, in an example embodiment, the third plurality of AV constellations is determined and/or generated by applying respective location perturbations to the AV locations of one or more AV constellations of the second plurality of AV constellations. In various embodiments, the one or more AV constellations are selected from the second plurality of AV constellations based on the respective positioning scores. For example, the one or more AV constellations selected from the second plurality of AV constellations may be the one or more AV constellations of the second plurality of AV constellations that are associated with the respective positioning scores indicating the most accurate positioning (e.g., the 99^{th} percentile, 95^{th} percentile, 90^{th} percentile, 80^{th} percentile, 75^{th} percentile, 70^{th} percentile, and/or the like). In various embodiments, the one or more AV constellations are selected randomly from the second plurality of AV constellations based on a weight associated therewith corresponding to the respective positioning score. In various embodiments, the respective location perturbations applied to one or more AV locations of a selected AV constellation are selected at random from a defined range (e.g., a distance of up to a quarter of a meter, up to half a meter, up to one meter, up to two meters, up to five meters, and/or the like). For example, the AV location of an AV constellation of the third plurality of AV constellations is within a defined volume about an AV location of the corresponding/selected AV constellation of the second plurality of AV constellations.

In various embodiments, additional pluralities of AV constellations (e.g., fourth plurality of AV constellations, fifth plurality of AV constellations, etc.) are generated similarly in an iterative manner until one or more convergence requirements is reached and/or met. In an example embodiment, the convergence requirement is a maximum number of iterations having been performed, a maximum amount of time used to perform the iterations, the AV locations of the AV constellation of the current iteration associated with the best respective positioning score are respectively within a threshold distance of corresponding AV locations of the AV constellations of one or more previous iterations associated with the best respective positioning score of the respective iteration, the AV locations of the AV constellation of the current iteration associated with the best respective positioning score being collectively within a threshold distance of the respective corresponding AV locations of the AV constellations of one or more previous iterations associated with the best respective positioning score of the respective iteration, and/or the like, and/or a combination thereof. As used herein, the term “best respective positioning score” means the respective positioning score that indicates the most accurate positioning at the position(s) of interest (of all the AV constellations of the respective iteration). For example, in an ith iteration, the AV constellation associated with the respective positioning score indicating the most accurate positioning of any of the AV constellations of the ith iteration comprises M AV locations {Lᵢ,ⱼ}ⱼ₌₀,...,_{M-1},where M ≤ N, where N is the number of AVs available for forming the AV constellation. In an example embodiment, the convergence requirement is met when |Lᵢ,ⱼ - Lₖ,ⱼ| ≤ D, for all 0 ≤ j ≤ M — 1, where D is the threshold distance and 0 ≤ k < i, and |L_{i,j} - Lₖ,ⱼ| is the distance (e.g., Euclidean distance) between the j^{th} AV location of the AV constellation associated with the respective positioning score of the i^{th} plurality of AV constellations indicating the most accurate positioning at the position(s) of interest of the i^{th} plurality of AV constellations. In an example embodiment, the convergence requirement is met when ∑ⱼ|L_{i,j} -L_{k,j}| ≤ D_{.}

At block 410, the network device 10 determines whether the convergence requirement(s) have been met. For example, the network device 10 comprises means, such as processor 12, memory 14, and/or the like, for determining whether the convergence requirement(s) have been met. For example, the number of iterations performed, the amount of time spent generating AV constellations of the various pluralities of AV constellations, the convergence of and/or distance between the AV locations of the AV constellation of the corresponding plurality of AV constellations that is associated with the best respective positioning score and the respective corresponding AV locations of the AV constellation associated with the best respective positioning score of respective one or more previous iterations, and/or the like, may be evaluated to determine whether the convergence requirement has been met.

When it is determined, at block 410, that the convergence requirement has not been met, the process returns to block 406 and another plurality of AV constellations is generated and the corresponding respective positioning scores are determined. When it is determined, at block 410, that the convergence requirement has been met, the process continues to block 412.

At block 412, the network device 10 compiles a group of selectable constellations and selects a preferred AV constellation therefrom. For example, the network device 10 comprises means, such as processor 12, memory 14, and/or the like, for compiling a group of selectable constellations and selecting the preferred AV constellation from the group of selectable constellations. In an example embodiment, the group of selectable constellations is generated and/or compiled based at least in part on one or more of the first plurality of AV constellations or the second plurality of AV constellations. In an example embodiment, the group of selectable constellations comprises and/or consists of the AV constellations of the plurality of AV constellations of the current/final iteration. In an example embodiment, the group of selectable constellations comprises and/or consists of the AV constellations of the pluralities of AV constellations of multiple iterations. In an example embodiment, the group of selectable constellations comprises the AV constellations of the first plurality of AV constellations and/or the second plurality of AV constellations. In an example embodiment, the group of selectable constellations comprises the AV constellations of the first plurality of AV constellations, the second plurality of AV constellations, the third plurality of AV constellations, and/or any additional pluralities of AV constellations.

In various embodiments, the preferred AV constellation is selected from the group of selectable constellations. In various embodiments, the preferred AV constellation s the AV constellation of the group of selectable constellations associated with the best respective positioning score. For example, the preferred AV constellation is the AV constellation of the group of selectable constellations that is expected to provide the most accurate positioning at the position(s) of interest of any of the AV constellations of the group of selectable constellations.

In various embodiments, the preferred AV constellation comprises and/or defines respective AV locations for generating and/or physically enacting the preferred AV constellation at the geographic area. In an example embodiment, the respective AV locations are provided in geographic coordinates (e.g., latitude, longitude, elevation/altitude/height). In an example embodiment, the respective AV locations are provided as relational coordinates with respect to a reference point located at the geographic area.

At block 414, the network device 10 (or another computing entity) determines respective travel paths from the current locations of the AVs to the respective corresponding AV locations of the preferred AV constellation. For example, the network device 10 comprises means, such as processor 12, memory 14, and/or the like for determining respective travel paths from the current locations of the AVs to the respective corresponding AV locations of the preferred AV constellation. In an example embodiment, the travel path from the current location of an AV to a respective AV location of the preferred AV constellation is a straight line between the current location and the respective AV location. In an example embodiment, the travel path from the current location of an AV to a respective AV location of the preferred AV constellation is a path that avoids any obstacles between the current location of the AV and the respective AV location of the preferred AV constellation. For example, the travel paths are determined based at least in part on obstacle information for the geographic area, in various embodiments. In an example embodiment, the travel path from the current location of an AV to a respective AV location of the preferred AV constellation is a path that avoids any obstacles between the current location of the AV and the respective AV location of the preferred AV constellation that is no more than a set distance or a set percentage longer than a straight line from the current location of the AV and the respective AV location. For example, when the distance between the current location of the AV and the respective AV location of the preferred AV constellation is distance s, the length of the travel path is no more than (1 + p)s, where 100 p is the set percentage. In an example embodiment, p = 0. In another example, when the distance between the current location of the AV and the respective AV location of the preferred AV constellation is distance s, the length of the travel path is no more than a + s, where a is the set distance. In an example embodiment, a = 0.

At block 416, the network device 10 (or another computing entity) generates and provides respective instructions configured to cause the AVs to respectively traverse the respective travel paths. For example, the network device 10 comprises means, such as processor 12, memory 14, communications interface 16, and/or the like for generating and providing respective instructions configured to cause the AVs to respectively traverse the respective travel paths. For example, first instructions are generated and provided such that the first instructions are received by a first AV. The first instructions are configured to, when processed and/or executed by the first AV, to cause the first AV to traverse a first travel path from the current location of the first AV to a first AV location of the preferred AV constellation. Thus, processing and/or execution of the respective instructions by respective ones of the set number of AVs at the geographic area causes the preferred AV constellation to be physically enacted.

### B. Example Operation of a Network Device to Generate a First Plurality of AV Constellations

FIG. 5 provides a flowchart illustrating various processes, procedures, operations, and/or the like for generating a first plurality of AV constellations, according to an example embodiment. For example, the processes, procedures, operations, and/or the like illustrated in FIG. 5 are performed as part of block 402, in an example embodiment. Starting at block 502, the network device 10 obtains the respective current locations of the set number of AVs (e.g., the AVs available at the geographic area for forming the preferred AV constellation). For example, the network device 10 comprises means, such as processor 12, memory 14, communications interface 16, user interface 18, and/or the like, for obtaining the respective current locations of the set number of AVs. For example, the network device 10 may extract or read the respective current locations of the set number of AVs from memory 14. For example, the respective current locations of the set number of AVs may be determined based on the AV locations of the preferred AV constellation currently being implemented by the AVs at the geographic area. In an example embodiment, the network device 10 may poll the AVs 30 or cause the AVs 30 to be polled (e.g., by a computing entity configured for controlling the AVs 30 and possibly located at the geographic area) such that the AVs 30 provide their respective current locations for receipt by the network device 10. In yet another example, a user may enter the respective current locations of the AVs via a user interface 18 of the network device 10.

In various embodiments, the respective current locations are three dimensional locations. In an example embodiment, the respective current locations are provided in geographic coordinates (e.g., latitude, longitude, elevation/altitude/height). In an example embodiment, the respective current locations are provided as relational coordinates with respect to a reference point located at the geographic area.

At block 504, the network device 10 obtains obstacle information for the geographic area. For example, the network device 10 comprises means, such as processor 12, memory 14, communications interface 16, and/or the like, for obtaining obstacle information for the geographic area. In various embodiment, the obstacle information for the geographic area identifies locations, spaces, and/or volumes in and/or around the geographic area where obstacles are located. In various embodiments, obstacles are any objects, items, structures, and/or the like in the geographic area. For example, when the geographic area comprises a building, the obstacle information for the geographic area may detail and/or indicate the location of the exterior walls, roof, exterior details and/or decorations, exterior structural components and/or the like of the building. For example, the obstacle information for the geographic area indicates where trees, bushes, street lights, and/or other objects items, structures, and/or the like are located about the geographic area and/or exterior to a building and/or venue of the geographic area. For example, the obstacle information may indicate the location of objects for which it is desirable to prevent collisions between a respective one of the objects and an AV 30.

At block 506, the network device 10 randomly generates a constellation. For example, the network device 10 comprises means, such as processor 12, memory 14, and/or the like, for randomly generating a constellation. For example, a set number of AV locations about the geographic area are randomly selected, in an example embodiment. For example, a location about the geographic area is randomly selected for each AV of the set number of AVs (e.g., the AVs available for physically enacting and/or forming the AV constellation). In various embodiments, the AV locations are selected such that each AV location is exterior to any building located at the geographic area and that each AV location is at a location that is not occupied by an obstacle (as indicated by the obstacle information for the geographic area). For example, the AV locations are randomly selected from a volume defined by boundaries of the geographic area, a set vertical dimension, and the obstacle information for the geographic area. In an example embodiment, the set vertical dimension is defined by the capabilities of the AVs, a particular vertical distance beyond the height of any building located at the geographic area, and/or the like.

At block 508, the network device 10 determines whether a potential travel path from a respective current location of a respective AV to a respective corresponding AV location of the AV constellation exists for each AV location of the AV constellation. For example, the network device comprises means, such as processor 12, memory 14, and/or the like for determining whether a potential travel path from a respective current location of a respective AV to a respective corresponding AV location of the AV constellation exists for each AV location of the AV constellation. In an example embodiment, the potential travel path from the current location of an AV to a respective AV location of the preferred AV constellation is a path between the current location of the AV and the respective AV location that avoids obstacles (e.g., does not intersect any obstacles and/or cross any volumes occupied by obstacles) indicated by the obstacle information for the geographic area and that satisfies a path length criteria. In an example embodiment, the path length criteria requires that the length of a potential travel path is no longer than a set distance or a set percentage longer than a straight line from the current location of the AV to the respective AV location of the AV constellation. For example, in an example embodiment, the path length criteria requires that the length of a potential travel path is no more than (1 + p)s, where s is the length of a straight line between the current location of the AV to the respective AV location of the AV constellation and lOOp is the set percentage. In an example embodiment, p = 0. In another example, when the distance between the current location of the AV and the respective AV location of the preferred AV constellation is distance s, the length of the travel path is no more than a + s, where a is the set distance. In an example embodiment, a = 0.

When, at block 508, it is determined that a potential travel path does not exist for at least one AV location of the AV constellation, the AV constellation is discarded at block 510. For example, the network device 10 may discarded the AV constellation and return to block 506 to randomly generate another AV constellation. For example, the network word device 10 comprises means, such as processor 12, memory 14, and/or the like, to discard the AV constellation when it is determined that a potential travel path does not exist for at least one AV location of the AV constellation.

When, at block 508, it is determined that potential travel paths do exist for each AV location of the AV constellation, the process continues to block 512. At block 512, the AV constellation is added to the first plurality of AV constellations. For example, the network device 10 comprises means, such as processor 12, memory 14, and/or the like, for adding the AV constellation to the first plurality of AV constellations responsive to determining that potential travel paths exist for each AV location of the AV constellation.

At block 514, the network device 10 determines whether the number of AV constellations in the first plurality of AV constellations satisfies a first quantity criteria. For example, the network device 10 comprises means, such as processor 12, memory 14, and/or the like for determining whether the number of AV constellation in the first plurality of AV constellations satisfies the first quantity criteria. For example, the first quantity criteria may indicate the number of AV constellations that should be included in the first plurality of AV constellations. When the number of AV constellations in the first plurality of AV constellations does not satisfy the first quantity criteria (e.g., the number of AV constellations in the first plurality of AV constellations is less than a first specified quantity), the process returns to block 506 and another AV constellation is randomly generated. When the number of AV constellations in the first plurality of AV constellations does satisfy the first quantity criteria (e.g., the number of AV constellations in the first plurality of AV constellations is at least a first specified quantity), the process continues to block 516.

At block 516, the first plurality of AV constellations is returned. For example, the network device 10 provides the first plurality of AV constellations for use by the preferred AV constellation generation and/or determination process. For example, the network device 10 comprises means, such as processor 12, memory 14, and/or the like, for returning the first plurality of AV constellations, for use at block 404 for FIG. 4, for example.

### C. Example Operation of a Network Device to Generate a Second Plurality of AV Constellations

FIG. 6 provides a flowchart illustrating various processes, procedures, operations, and/or the like for generating a second plurality of AV constellations, according to an example embodiment. For example, the processes, procedures, operations, and/or the like illustrated in FIG. 6 are performed as part of block 406, in an example embodiment.

Starting at block 602, the network device 10 randomly selects a first AV constellation from the first plurality of constellations. For example, the network device 10 comprises means, such as processor 12, memory 14, and/or the like, for randomly selecting a first AV constellation from the first plurality of constellations. In an example embodiment, each AV constellation is assigned a weight determined based at least in part on the corresponding respective positioning score. For example, AV constellations of the first plurality of AV constellations associated with respective positioning scores indicating better positioning accuracy are assigned a larger weight (e.g., are more likely to be selected in the random selection process) than AV constellations of the first plurality of AV constellations associated with respective positioning scores indicating poorer positioning accuracy. For example, in an example embodiment a weighted random selection process is used to randomly select a first AV constellation from the first plurality of AV constellations based at least in part on the respective positioning scores.

At block 604, the network device 10 randomly selects a respective location perturbation for one or more AV locations of the first AV constellation. For example, the network device 10 comprises means, such as processor 12, memory 14, and/or the like, for randomly selecting a respective location perturbation for one or more AV locations of the first AV constellation. In an example embodiment, a respective location perturbation is selected for each of the AV locations of the first AV constellation. In an example embodiment, a respective location perturbation is randomly selected for one to M - 1 of the AV locations of the first AV constellation, where M is the number of AV locations in the first AV constellation.

In various embodiments, the respective location perturbations are selected at random from a defined range (e.g., a distance of up to a quarter of a meter, up to half a meter, up to one meter, up to two meters, up to five meters, and/or the like). In an example embodiment, the respective location perturbation is a three-dimensional location perturbation. For example, the location perturbation is of the form (Δx, Δy, Δz), where each of Δx, Δy, and Δz are randomly selected from a range of —r to r, where |r| is the largest allowed one-dimensional perturbation for the particular embodiment. In various embodiments, |r| is five centimeters, ten centimeters, twenty-five centimeters, fifty centimeters, one meter, two meters, five meters, and/or the like. In an example embodiment, the largest allowed one-dimensional perturbation is determined based on the corresponding dimension (e.g., x, y, or z), a dimension or volume of the geographic area, and/or the like. In an example embodiment, the location perturbations randomly selected for an AV location of the first AV constellation are configured to satisfy

$$\sqrt{Δ {x}^{2} + Δ {y}^{2} + Δ {z}^{2}} \leq R ,$$

where R is a defined distance. For example, the result of perturbing an AV location of the first AV constellation is a new AV location disposed within a defined volume about the AV location of the first AV constellation.

At block 606, the network device 10 modifies the AV locations of the first AV constellation based on the respective location perturbations to generate a new AV constellation. For example, the network device 10 comprises means, such as processor 12, memory 14, and/or the like, for modifying the AV locations of the first AV constellation based on the respective location perturbations to generate a new AV constellation. For example, if an AV location of the first AV constellation is represented as (x, y, z) and the corresponding respective location perturbation is represented as (Δx, Δx, Δz), the modified AV location of the new AV constellation may then be represented as (x + Δx, y + Δy, z + Δz).

In various embodiments, the location perturbations are selected such that the modified AV locations of the new AV constellation are not disposed at the location of an obstacle and/or within a volume of the geographic area comprising an obstacle, as indicated by the obstacle information for the geographic area. In various embodiments, one or more tests or checks of the new AV location may be performed to ensure that the modified AV locations of the new AV constellation are not disposed at the location of an obstacle and/or within a volume of the geographic area comprising an obstacle and/or that respective potential travel paths from respective current locations of the AVs at the geographic area to respective modified AV locations exists. For example, a process similar to that described with respect to block 508 may be performed to filter out new AV constellations for which respective potential travel paths from respective current locations of the AVs at the geographic area to respective modified AV locations do not exist for at least one of the modified AV locations. For example, when it is determined that at least one of the modified AV locations of the new AV constellation is disposed at the location of an obstacle and/or within a volume of the geographic area comprising an obstacle (as indicated by the obstacle information for the geographic area) and/or that a potential travel path from a respective current location of an AV at the geographic area to one of the modified AV locations does not exist, the process may return to block 604 and location perturbations for one or more AV locations of the first AV constellation may be randomly reselected.

At block 608, the network device 10 adds the new AV constellation to the second plurality of AV constellations. For example, the network device 10 comprises means, such as processor 12, memory 14, and/or the like for adding the new AV constellation to the second plurality of AV constellations. For example, responsive to determining that each modified AV location of the new AV constellation is not disposed at a location of an obstacle and/or within a volume of the geographic area comprising an obstacle (as indicated by the obstacle information for the geographic area) and/or that respective potential travel paths from the respective current locations of the AVs at the geographic area to respective modified AV locations do exist for the modified AV locations of the new AV constellation, the new AV constellation is added to the second plurality of AV constellations.

At block 610, the network device 10 determines whether the number of AV constellations in the second plurality of AV constellations satisfies a second quantity criteria. For example, the network device 10 comprises means, such as processor 12, memory 14, and/or the like for determining whether the number of AV constellation in the second plurality of AV constellations satisfies the second quantity criteria. For example, the second quantity criteria may indicate the number of AV constellations that should be included in the second plurality of AV constellations. When the number of AV constellations in the second plurality of AV constellations does not satisfy the second quantity criteria (e.g., the number of AV constellations in the second plurality of AV constellations is less than a second specified quantity), the process returns to block 602 and another AV constellation is randomly selected (based at least in part on a corresponding weight) from the first plurality of AV constellations. When the number of AV constellations in the second plurality of AV constellations does satisfy the quantity criteria (e.g., the number of AV constellations in the second plurality of AV constellations is at least a second specified quantity), the process continues to block 612. In an example embodiment, the first specified quantity and the second specified quantity are equal to one another.

At block 612, the second plurality of AV constellations is returned. For example, the network device 10 provides the second plurality of AV constellations for use by the preferred AV constellation generation and/or determination process. For example, the network device 10 comprises means, such as processor 12, memory 14, and/or the like, for returning the second plurality of AV constellations, for use at block 408 for FIG. 4, for example.

### D. Example Operation of a Network Device to Determine a New Preferred AV Constellation

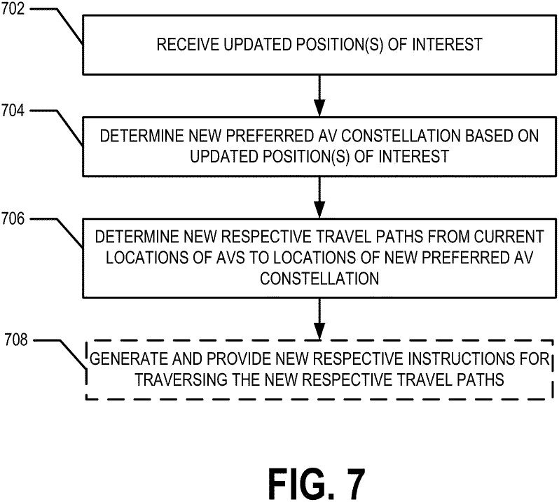

FIG. 7 provides a flowchart illustrating processes, procedures, operations, and/or the like for generating and/or determining a new preferred AV constellation. For example, a set number of AVs may be deployed at a geographic area to enable positioning within the geographic area (and particularly at the position(s) of interest). When it is determined that the at least one position(or one or more positions of interest when the position(s) of interest is a plurality of positions of interest) of interest changes, a new preferred AV constellation is determined and may be physically enacted. For example, the respective position(s) of interest are each associated with a respective mobile device of a plurality of mobile devices located at the geographic area, in an example embodiment, and when at least one of the mobile devices changes locations within the geographic area, at least one updated position of interest may be determined and/or used to determine a new preferred AV constellation.

Starting at block 702, the network device 10 receives one or more updated positions of interest. For example, the network device 10 comprises means, such as processor 12, memory 14, communications interface 16, and/or the like, for receiving one or more updated positions of interest. For example, one or more positions of interest may be the respective positions of one or more mobile devices 20 and the mobile devices 20 may change positions. For example, a user carrying and/or physically associated with a mobile device 20 may move from one space within the geographic area to another space within the geographic area (e.g., move rooms, change floors/levels, and/or the like). For example, the mobile device 20 may determine a position estimate for itself based on observed radio signals emitted and/or broadcasted by the AVs 30 forming the physical AV constellation and/or based on communication with the AVs 30 forming the physical AV constellation. the mobile device 20 may then provide (e.g., transmit) the position estimate such that the network device 10 receives the position estimate. In another example, a mobile device 20 may observe signals emitted and/or broadcasted by the AVs 30 forming the physical AV constellation and provide (e.g., transmit) information characterizing the observed signals such that the network device 10, a Cloud-based service, and/or the like, determines a position estimate for the mobile device 20.

In various embodiments, the network device 10 is provided with an updated position for at least one of the position(s) of interest periodically (e.g., every minute, every five minutes, every ten minutes, and/or the like). In various embodiments, the network device 10 is provided with an updated position for at least one of the position(s) of interest when it is determined that the respective position of interest (e.g., the mobile device 20 associated with the respective position of interest) has moved for than a threshold movement distance, changed floors and/or levels, and/or the like.

At block 704, the network device 10 determines and/or generates a new preferred AV constellation based on the at least one updated position of interest. For example, the network device 10 comprises means, such as processor 12, memory 14, and/or the like, for determining and/or generating a new preferred AV constellation based on the at least one updated position of interest. For example, the network device 10 may perform the processes, procedures, operations, and/or the like illustrated in FIG. 4 using the at least one updated position of interest to determine the respective positioning scores to determine and/or generate a new preferred AV constellation.

At block 706, the network device 10 (or another computing entity) determines respective travel paths from the current locations of the AVs to the respective corresponding AV locations of the new preferred AV constellation. For example, the network device 10 comprises means, such as processor 12, memory 14, and/or the like for determining respective travel paths from the current locations of the AVs to the respective corresponding AV locations of the new preferred AV constellation. In an example embodiment, the travel path from the current location of an AV to a respective AV location of the new preferred AV constellation is a straight line between the current location and the respective AV location. In an example embodiment, the travel path from the current location of an AV to a respective AV location of the new preferred AV constellation is a path that avoids any obstacles between the current location of the AV and the respective AV location of the new preferred AV constellation. For example, the travel paths are determined based at least in part on obstacle information for the geographic area, in various embodiments. In an example embodiment, the travel path from the current location of an AV to a respective AV location of the new preferred AV constellation is a path that avoids any obstacles between the current location of the AV and the respective AV location of the new preferred AV constellation that is no more than a set distance or a set percentage longer than a straight line from the current location of the AV and the respective AV location. For example, when the (straight line) distance between the current location of the AV and the respective AV location of the new preferred AV constellation is distance s, the length of the travel path is no more than (1 + p)s, where 100 p is the set percentage. In an example embodiment, p = 0. In another example, when the distance between the current location of the AV and the respective AV location of the preferred AV constellation is distance s, the length of the travel path is no more than a + s, where a is the set distance. In an example embodiment, a = 0.

At block 708, the network device 10 (or another computing entity) generates and provides respective instructions configured to cause the AVs to respectively traverse the respective travel paths. For example, the network device 10 comprises means, such as processor 12, memory 14, communications interface 16, and/or the like for generating and providing respective instructions configured to cause the AVs to respectively traverse the respective travel paths. For example, first instructions are generated and provided such that the first instructions are received by a first AV. The first instructions are configured to, when processed and/or executed by the first AV, to cause the first AV to traverse a first travel path from the current location of the first AV to a first AV location of the new preferred AV constellation. Thus, processing and/or execution of the respective instructions by respective ones of the set number of AVs at the geographic area causes the new preferred AV constellation to be physically enacted.

### E. Example Operation of an Aerial Vehicle to Enable Positioning in a Geographic Area

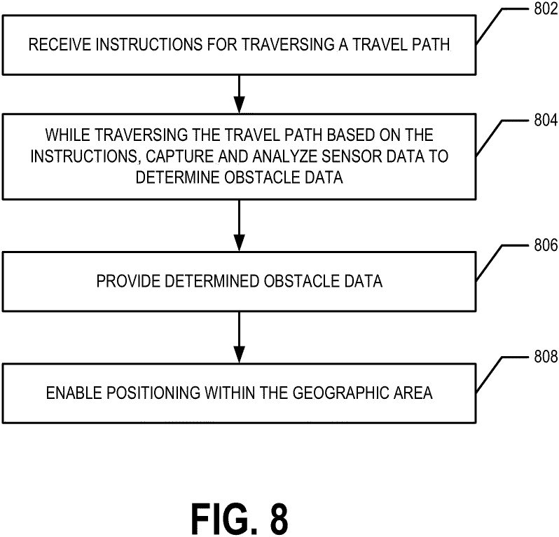

FIG. 8 provides a flowchart illustrating processes, procedures, operations, and/or the like performed by an AV 30, for example, to enable positioning within a geographic area. In various embodiments, a plurality of AVs 30 (e.g., a set number of AVs 30) are available at the geographic area for physically enacting a preferred AV constellation. Each AV 30 of the AVs available at the geographic area for physical enacting the preferred AV constellation are configured to, when participating in physically enacting the preferred AV constellation, enable positioning within the geographic area. For example, the AVs 30 may emit and/or broadcast signals (e.g., radio frequency signals) that are observable by mobile devices 20 within the geographic area such that respective position estimates for the mobile devices 20 within the geographic area may be generated based on the signals observed by the respective mobile devices 20 and/or characteristics of the signals observed by the respective mobile devices 20.

Starting at block 802, an AV 30 receives instructions for traversing a travel path. For example, an AV 30 comprises means, such as processor 32, memory 34, communications interface 36, and/or the like, for receiving instructions for traversing a travel path. In an example embodiment, the instructions where generated and provided by the network device 10.

At block 804, the AV 30 processes and/or executes the instructions such that the AV 30 traverses the travel path. For example, the AV 30 comprises means, such as processor 32, memory 34, sensors 39, flying systems and/or vehicle control and/or routing systems, and/or the like, for processing and/or executing the instructions such that the AV 30 traverses (e.g., flies along) the travel path. As the AV 30 traverses the travel path, the sensors 39 capture sensor data. The sensor data is monitored, processed, analyzed, and/or the like in (near) real-time by the AV 30 (e.g., using processor 32) to track a location of the AV 30 and/or to detect/identify obstacles located proximate the AV 30. As used herein, an obstacle is located proximate the AV 30 when the sensors 39 of the AV 30 can observe the obstacle such that the obstacle is detected and/or identified by the AV 30.

Based on any detected and/or identified obstacles, the AV 30 generates obstacle data. In various embodiments, the obstacle data includes a three-dimensional location of the obstacle, a geometry of the obstacle, and/or any other information/data corresponding to the obstacle that is determinable based on the sensor data captured by the sensors 39.

At block 806, the AV 30 provides the determined obstacle data. For example, the AV 30 comprises means, such as processor 32, memory 34, communications interface 36, and/or the like for providing the determined obstacle data. In various embodiments, the determined obstacle data is provided such that the network device 10 receives the determined obstacle data.

At block 808, the AV 30 completes the traversal of the travel path and enables positioning within the geographic area from the AV location indicated by the travel path. For example, the AV 30 comprises means, such as processor 32, memory 34, communications interface 36, sensors 39, and/or the like for completing the traversal of the travel path and enabling positioning within the geographic area from the AV location indicated by the travel path.

In an example embodiment, the AV 30 is configured to provide a travel path traversal completed message when the AV 30 has completed traversing the travel path. For example, the AV 30 may provide (e.g., transmit) a travel path traversal completed message configured to indicate that the AV 30 is located at and/or is maintaining itself at a particular location (e.g., the AV location indicated by the travel path). In an example embodiment, the travel path traversal completed message is received by the network device 10, an AV control computing entity possibly located at the geographic area, and/or the like.

For example, in an example embodiment, the AV 30 is configured to maintain the AV location indicated by the travel path and emit and/or broadcast signals (e.g., radio frequency signals) that are observable by mobile devices 20 within at least a portion of the geographic area. In an example embodiment, the signals emitted and/or broadcasted by the AV 30 comprise an AV identifier configured to identify the AV 30 and/or an indication of the three-dimensional location of the AV 30 (e.g., latitude, longitude, and altitude/elevation/height; or local/relational coordinates). In various embodiments, the emitted and/or broadcasted signals (e.g., radio frequency signals) are configured to enable positioning (e.g., radio-based positioning) of mobile devices 20 located within at least a portion of the geographic area.

In various embodiments, the AV 30 may continue to maintain itself at the particular location (e.g., the location indicated by the travel path) and to enable positioning within at least a portion of the geographic area (e.g., emit and/or broadcast position-enabling signals) until the AV 30 receives another travel path.

### F. Example Operation of a Network Device to Update Obstacle Information for a Geographic Area

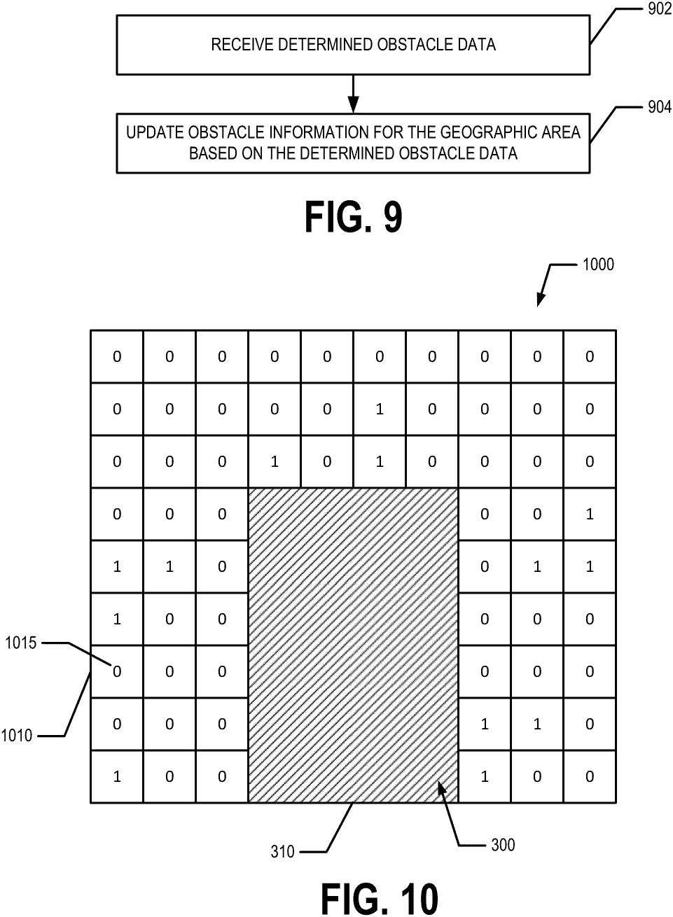

As noted above, the network device 10 stores and/or has access to obstacle information for the geographic area. the obstacle information for the geographic area may be used in the generation of a first plurality of AV constellations, a second plurality of AV constellations, a third or subsequent plurality of AV constellations, respective travel paths, and/or the like. In various embodiments, the AVs 30 enacting the physical AV constellation at the geographic area generated and/or determine obstacle data and provide the determined obstacle data such that the network device 10 receives the determined obstacle data. The network device 10 may then update and/or cause the updating of the obstacle information for the geographic information that is stored by the network device 10 (e.g., in memory 14) and/or otherwise accessible to the network device 10. FIG. 9 provides a flowchart illustrating processes, procedures, and/or operations that may be performed, for example, by the network device 10 to update the obstacle information for the geographic area.

Starting at block 902, the network device 10 receives determined obstacle data. For example, the network device 10 comprises means, such as processor 12, memory 14, communications interface 16, and/or the like, for receiving determined obstacle data. In various embodiments, the determined obstacle data was determined, generated, and/or provided by one or more AVs 30 at the geographic area.

At block 904, the network device 10 updates the obstacle information for the geographic area based on the determined obstacle data and stores the updated obstacle information for the geographic area (or causes the updated obstacle information for the geographic area to be stored). For example, the network device 10 comprises means, such as processor 12, memory 14, communications interface 16, and/or the like for updating the obstacle information for the geographic area and storing the updated obstacle information for the geographic area (or causing the updated obstacle information for the geographic area to be stored). For example, the network device 10 may incorporate the determined obstacle data into the obstacle information for the geographic area and/or aggregate the determined obstacle data with the obstacle information for the geographic area to generate updated obstacle information for the geographic area.

In an example embodiment, the obstacle information for the geographic area is a model (e.g., three-dimensional model) of the geographic area that describes and/or indicates the locations and/or geometries of stationary and/or static items, objects, and/or the like within the geographic area. For example, the obstacle information for the geographic area may comprise information relating to the location and/or geometries of trees, shrubs, light posts, signs, flag poles, portions of the exterior of a building or venue located at the geographic area, and/or the like. In an example embodiment, the obstacle information for the geographic area comprises feature information for each of the obstacle features known in the geographic area.

In an example embodiment, the obstacle information is a three-dimensional grid with each grid element (e.g., cuboid) labelled and/or associated with a binary indicator of whether the volume of the geographic area corresponding to the grid element comprises an obstacle. FIG. 10 illustrates a two dimensional portion of a three-dimensional grid representing obstacle information 1000 for a geographic area 300 comprising building 310. In the illustrated example, the obstacle information for the geographic area comprises an indication of dimensions of the building 310 or venue and a positioning of the building 310 or venue in the geographic area 300.

Each grid element 1010 is associated with a binary label 1015 that indicates whether the volume of the geographic area 300 corresponding to the respective grid element 1010 comprises an obstacle. For example, grid elements 1010 associated with respective binary labels 1015 of “0” may correspond to volumes of the geographic area 300 that are expected to be obstacle free while grid elements 1010 associated with respective binary labels 1015 of “1” may correspond to volumes of the geographic area that are expected to contain obstacles. For example, the AV locations of the AV constellations may be (randomly selected) such that they are not located in volumes corresponding to grid elements associated with binary labels indicating the expected presence of an obstacle therein. For example, respective travel paths from respective current AV locations to respective AV locations of an AV constellation may be configured to not pass through a volume corresponding to a grid element associated with a binary label indicating the expected presence of an obstacle therein.

In an example embodiment, to update the obstacle information for the geographic area based on the determined obstacle data, the network device 10 may determine and/or identify which grid element 1010 the location of the obstacle indicated in the determined obstacle data is located. When the binary label 1015 of the identified grid element 1010 corresponding to the location of the obstacle indicated by the determined obstacle data indicates that the corresponding volume of the geographic area is expected to include an obstacle, the binary label 15 for the identified grid element is maintained and, possibly, a counter is incremented indicating the confirmation of the presence of at least one obstacle in the corresponding volume of the geographic area. When the binary label 1015 of the identified grid element 1010 corresponding to the location of the obstacle indicated by the determined obstacle data indicates that the corresponding volume of the geographic area is not expected to include an obstacle, the binary label 15 for the identified grid element may be updated and/or modified to indicate the expected presence of an obstacle in the corresponding volume of the geographic area and, possibly, a counter is incremented indicating the detection of at least one obstacle in the corresponding volume of the geographic area.

### III. Technical Advantages

As described above, in various scenarios it may be desirable to be able to accurately determine the location of one or more individuals, assets, and/or mobile devices 20 (possibly associated with an individual or asset) within a geographic area. GNSS-based positioning of sufficient accuracy may not be available in at least portions of the geographic area and the infrastructure of the geographic area may be not be sufficient, sufficiently well known, and/or reliable in the current circumstances to provide other forms of positioning (e.g., radio-based positioning) of sufficient accuracy.

Various embodiments provide technical solutions to the technical problems of enabling accurate positioning within a geographic area without relying on GNSS-based positioning and/or the local infrastructure. For example, various embodiments provide a temporary and dynamic infrastructure through the physically enacted preferred AV constellation that enables accurate positioning of individuals, assets, and/or mobile devices 20 at position(s) of interest within the geographic area. The physically enacted preferred AV constellation may be updated to ensure that the position of one or more individuals, assets, and/or mobile devices 20 within geographic area can be accurately tracked in (near) real-time.

Various embodiments further provide the technical advantages of being able to efficiently determine a preferred AV constellation that is configured to enable accurate positioning at position(s) of interest within the geographic area, efficiently determined a preferred AV constellation that comprises AV locations that are not co-located with obstacles in the geographic area, determine travel paths that allow for quick and efficient re-location of AVs 30 and that avoid volumes of the geographic area known and/or expected to contain obstacles, and/or the like. Thus, various embodiments provide improvements to the field of positioning, temporarily enabling positioning within a geographic area, and enabling the accurate tracking of individuals, assets, and/or mobile devices 20 within a geographic area when GNSS-based and/or infrastructure-based (e.g., radio-based) positioning are not available, reliable, or sufficiently accurate.

### IV. Example Apparatus

The network device 10 and/or mobile device 20 of an example embodiment may be embodied by or associated with a variety of computing devices including, for example, a navigation system including a global navigation satellite system (GNSS), a cellular telephone, a mobile phone, a personal digital assistant (PDA), a watch, a camera, a computer, an Internet of things (IoT) item, router, routing switch, integrated access device, multiplexer, metropolitan area network (MAN) and/or wide area network (WAN) access device and/or other device that can communicate via a wireless communication protocol, generate a preferred UV constellation, use a genetic algorithm to generate a preferred UV constellation (e.g., using the respective positioning scores as the fitness function), and/or perform positioning. Additionally or alternatively, the network device 10 and/or mobile device 20 may be embodied in other types of computing devices, such as a server, a server group, a Cloud-based service, a personal computer, a computer workstation, a laptop computer, a plurality of networked computing devices or the like, that are configured to interact with an AV 30, generate a preferred UV constellation, generate and/or provide instructions for causing AVs 30 to adjust their respective locations in accordance with the preferred UV constellations, perform positioning and/or navigation-related functions, and/or the like. In an example embodiment, a mobile device 20 is a smartphone, tablet, other mobile device, and/or user device and an network device 10 is a server, server group, or Cloud-based service. In an example embodiment, an AV 30 is an unmanned, autonomous, semi-autonomous, and/or other aerial vehicle that may be programed and/or controlled to perform various tasks, such as capturing and providing images, item delivery and/or pickup, and/or the like.

In some embodiments, the processor 12, 22, 32 (and/or co-processors or any other processing circuitry assisting or otherwise associated with the processor) may be in communication with the memory device 14, 24, 34 via a bus for passing information among components of the apparatus. The memory device may be non-transitory and may include, for example, one or more volatile and/or non-volatile memories. In other words, for example, the memory device may be an electronic storage device (e.g., a non-transitory computer readable storage medium) comprising gates configured to store data (e.g., bits) that may be retrievable by a machine (e.g., a computing device like the processor). The memory device may be configured to store information, data, content, applications, instructions, or the like for enabling the apparatus to carry out various functions in accordance with an example embodiment of the present invention. For example, the memory device could be configured to buffer input data for processing by the processor. Additionally or alternatively, the memory device could be configured to store instructions for execution by the processor.

As described above, the network device 10 and/or mobile device 20 may be embodied by a computing entity and/or device and an AV 30 may comprise a computing entity and/or device (e.g., in addition to mechanical systems used for aerial navigation, and/or the like). However, in some embodiments, the network device 10, mobile device 20, and/or the computing entity and/or device of the AV 30 may be embodied as a chip or chip set. In other words, the network device 10, mobile device 20, and/or AV 30 may comprise one or more physical packages (e.g., chips) including materials, components and/or wires on a structural assembly (e.g., a baseboard). The structural assembly may provide physical strength, conservation of size, and/or limitation of electrical interaction for component circuitry included thereon. The apparatus may therefore, in some cases, be configured to implement an embodiment of the present invention on a single chip or as a single “system on a chip.” As such, in some cases, a chip or chipset may constitute means for performing one or more operations for providing the functionalities described herein.

The processor 12, 22, 32 may be embodied in a number of different ways. For example, the processor 12, 22, 32 may be embodied as one or more of various hardware processing means such as a coprocessor, a microprocessor, a controller, a digital signal processor (DSP), a processing element with or without an accompanying DSP, or various other processing circuitry including integrated circuits such as, for example, an ASIC (application specific integrated circuit), an FPGA (field programmable gate array), a microcontroller unit (MCU), a hardware accelerator, a special-purpose computer chip, or the like. As such, in some embodiments, the processor 12, 22, 32 may include one or more processing cores configured to perform independently. A multi-core processor may enable multiprocessing within a single physical package. Additionally or alternatively, the processor 12, 22, 32 may include one or more processors configured in tandem via the bus to enable independent execution of instructions, pipelining and/or multithreading. In various embodiments, the processor 12, 22, 32 may comprise a graphical processing unit (GPU).

In an example embodiment, the processor 12, 22, 32 may be configured to execute instructions stored in the memory device 14, 24, 34 or otherwise accessible to the processor. Alternatively or additionally, the processor may be configured to execute hard coded functionality. As such, whether configured by hardware or software methods, or by a combination thereof, the processor may represent an entity (e.g., physically embodied in circuitry) capable of performing operations according to an embodiment of the present invention while configured accordingly. Thus, for example, when the processor is embodied as an ASIC, FPGA or the like, the processor may be specifically configured hardware for conducting the operations described herein. Alternatively, as another example, when the processor is embodied as an executor of software instructions, the instructions may specifically configure the processor to perform the algorithms and/or operations described herein when the instructions are executed. However, in some cases, the processor may be a processor of a specific device (e.g., a pass-through display or a mobile terminal) configured to employ an embodiment of the present invention by further configuration of the processor by instructions for performing the algorithms and/or operations described herein. The processor may include, among other things, a clock, an arithmetic logic unit (ALU) and logic gates configured to support operation of the processor.

In some embodiments, the network device 10, mobile device 20, and/or AV 30 may include a user interface 18, 28, 38 that may, in turn, be in communication with the processor 12, 22, 32 to provide output to the user, such as one or more navigable routes to a destination from an origin, display of a position of a mobile device 20 within the geographic area, and/or the like, and, in some embodiments, to receive an indication of a user input. As such, the user interface 18, 28, 38 may include one or more output devices such as a display, speaker, and/or the like and, in some embodiments, may also include one or more input devices such as a keyboard, a mouse, a joystick, a touch screen, touch areas, soft keys, a microphone, a speaker, or other input/output mechanisms. Alternatively or additionally, the processor may comprise user interface circuitry configured to control at least some functions of one or more user interface elements such as a display and, in some embodiments, a speaker, ringer, microphone and/or the like. The processor and/or user interface circuitry comprising the processor may be configured to control one or more functions of one or more user interface elements through computer program instructions (e.g., software and/or firmware) stored on a memory accessible to the processor 12, 22, 32 (e.g., memory device 14, 24, 34 and/or the like).

The network device 10, mobile device 20, and/or AV 30 may optionally include a communication interface 16, 26, 36. The communication interface 16, 26, 36 may be any means such as a device or circuitry embodied in either hardware or a combination of hardware and software that is configured to receive and/or transmit data from/to a network and/or any other device or module in communication with the apparatus. In this regard, the communication interface may include, for example, an antenna (or multiple antennas) and supporting hardware and/or software for enabling communications with a wireless communication network. Additionally or alternatively, the communication interface may include the circuitry for interacting with the antenna(s) to cause transmission of signals via the antenna(s) or to handle receipt of signals received via the antenna(s). In some environments, the communication interface may alternatively or also support wired communication. As such, for example, the communication interface may include a communication modem and/or other hardware/software for supporting communication via cable, digital subscriber line (DSL), universal serial bus (USB) or other mechanisms.

In various embodiments, a network device 10, mobile device 20, and/or AV 30 may comprise a component (e.g., memory 14, 24, 34, and/or another component) that stores a digital map (e.g., in the form of a geographic database). In an example embodiment, the digital map comprises information regarding the geometry and/or topology of the geographic area, obstacle information for the geographic area, and/or the like.

In various embodiments, the digital map (e.g., in the form of a geographic database) comprises a first plurality of data records, each of the first plurality of data records representing a corresponding TME, wherein at least some of said first plurality of data records map information/data indicating current traffic conditions along the corresponding TME. For example, the geographic database may include a variety of data (e.g., map information/data) utilized in various navigation functions such as constructing a route or navigation path, determining the time to traverse the route or navigation path, matching a geolocation (e.g., a GNSS determined location, a radio-based positioning determined location, an AV constellation determined location) to a point on a map, a lane of a lane network, and/or link, one or more localization features and a corresponding location of each localization feature, and/or the like. For example, a geographic database may include road segment, segment, link, lane segment, or traversable map element (TME) data records, point of interest (POI) data records, localization feature data records, and other data records. More, fewer or different data records can be provided. In one embodiment, the other data records include cartographic (“carto”) data records, routing data, and maneuver data. One or more portions, components, areas, layers, features, text, and/or symbols of the POI or event data can be stored in, linked to, and/or associated with one or more of these data records. For example, one or more portions of the POI, event data, or recorded route information can be matched with respective map or geographic records via position or GNSS data associations (such as using known or future map matching or geo-coding techniques), for example. In an example embodiment, the data records may comprise nodes, connection information/data, intersection data records, link data records, POI data records, and/or other data records. In an example embodiment, the network device 10 may be configured to modify, update, and/or the like one or more data records of the geographic database. For example, the network device 10 may modify, update, generate, and/or the like map information/data corresponding to TMEs, links, lanes, road segments, travel lanes of road segments, nodes, intersection, pedestrian walkways, elevators, staircases, and/or the like and/or the corresponding data records (e.g., to add or update updated map information/data including, for example, current traffic conditions along a corresponding TME), a localization layer (e.g., comprising localization features) and/or the corresponding data records, and/or the like.

In an example embodiment, the TME data records are links, lanes, or segments (e.g., maneuvers of a maneuver graph, representing roads, travel lanes of roads, streets, paths, navigable aerial route segments, and/or the like as can be used in the calculated route or recorded route information for determination of one or more personalized routes). The intersection data records are ending points corresponding to the respective links, lanes, or segments of the TME data records. The TME data records and the intersection data records represent a road network, such as used by vehicles, cars, bicycles, and/or other entities. Alternatively, the geographic database can contain path segment and intersection data records or nodes and connection information/data or other data that represent pedestrian paths or areas in addition to or instead of the vehicle road record data, for example. Alternatively and/or additionally, the geographic database can contain navigable aerial route segments or nodes and connection information/data or other data that represent an navigable aerial network, for example.

The TMEs, lane/road/link/path segments, segments, intersections, and/or nodes can be associated with attributes, such as geographic coordinates, street names, address ranges, speed limits, turn restrictions at intersections, and other navigation related attributes, as well as POIs, such as gasoline stations, hotels, restaurants, museums, stadiums, offices, automobile dealerships, auto repair shops, buildings, stores, parks, etc. The geographic database can include data about the POIs and their respective locations in the POI data records. The geographic database can also include data about places, such as cities, towns, or other communities, and other geographic features, such as bodies of water, mountain ranges, etc. Such place or feature data can be part of the POI data or can be associated with POIs or POI data records (such as a data point used for displaying or representing a position of a city). In addition, the geographic database can include and/or be associated with event data (e.g., traffic incidents, constructions, scheduled events, unscheduled events, etc.) associated with the POI data records or other records of the geographic database.

The geographic database can be maintained by the content provider (e.g., a map developer) in association with the services platform. By way of example, the map developer can collect geographic data to generate and enhance the geographic database. There can be different ways used by the map developer to collect data. These ways can include obtaining data from other sources, such as municipalities or respective geographic authorities. In addition, the map developer can employ field personnel to travel by vehicle along roads throughout the geographic region to observe features and/or record information about them, for example. Also, remote sensing, such as aerial or satellite photography, can be used.

The geographic database can be a master geographic database stored in a format that facilitates updating, maintenance, and development. For example, the master geographic database or data in the master geographic database can be in an Oracle spatial format or other spatial format, such as for development or production purposes. The Oracle spatial format or development/production database can be compiled into a delivery format, such as a geographic data files (GDF) format. The data in the production and/or delivery formats can be compiled or further compiled to form geographic database products or databases, which can be used in end user navigation devices or systems.

For example, geographic data is compiled (such as into a platform specification format (PSF) format) to organize and/or configure the data for performing navigation-related functions and/or services, such as route calculation, route guidance, map display, speed calculation, distance and travel time functions, and other functions. The navigation-related functions can correspond to vehicle navigation or other types of navigation. The compilation to produce the end user databases can be performed by a party or entity separate from the map developer. For example, a customer of the map developer, such as a navigation device developer or other end user device developer, can perform compilation on a received geographic database in a delivery format to produce one or more compiled navigation databases. Regardless of the manner in which the databases are compiled and maintained, an edge device 10, computing device 20, and/or AV 30 in accordance with an example embodiment may determine the time to traverse a route through at least a portion of a navigable network.

### V. Apparatus, Methods, and Computer Program Products

As described above, FIGS. 4, 5, 6, 7, 8, and 9 illustrate flowcharts of a network device 10, mobile device 20, and/or AV 30, methods, and computer program products according to an example embodiment of the invention. It will be understood that each block of the flowcharts, and combinations of blocks in the flowcharts, may be implemented by various means, such as hardware, firmware, processor, circuitry, and/or other devices associated with execution of software including one or more computer program instructions. For example, one or more of the procedures described above may be embodied by computer program instructions. In this regard, the computer program instructions which embody the procedures described above may be stored by the memory device 14, 24, 34 of an apparatus employing an embodiment of the present invention and executed by the processor 12, 22, 32 of the apparatus. As will be appreciated, any such computer program instructions may be loaded onto a computer or other programmable apparatus (e.g., hardware) to produce a machine, such that the resulting computer or other programmable apparatus implements the functions specified in the flowchart blocks. These computer program instructions may also be stored in a computer-readable memory that may direct a computer or other programmable apparatus to function in a particular manner, such that the instructions stored in the computer-readable memory produce an article of manufacture the execution of which implements the function specified in the flowchart blocks. The computer program instructions may also be loaded onto a computer or other programmable apparatus to cause a series of operations to be performed on the computer or other programmable apparatus to produce a computer-implemented process such that the instructions which execute on the computer or other programmable apparatus provide operations for implementing the functions specified in the flowchart blocks.

Accordingly, blocks of the flowcharts support combinations of means for performing the specified functions and combinations of operations for performing the specified functions for performing the specified functions. It will also be understood that one or more blocks of the flowcharts, and combinations of blocks in the flowcharts, can be implemented by special purpose hardware-based computer systems which perform the specified functions, or combinations of special purpose hardware and computer instructions.

In some embodiments, certain ones of the operations above may be modified or further amplified. Furthermore, in some embodiments, additional optional operations may be included. Modifications, additions, or amplifications to the operations above may be performed in any order and in any combination.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Moreover, although the foregoing descriptions and the associated drawings describe example embodiments in the context of certain example combinations of elements and/or functions, it should be appreciated that different combinations of elements and/or functions may be provided by alternative embodiments without departing from the scope of the appended claims. In this regard, for example, different combinations of elements and/or functions than those explicitly described above are also contemplated as may be set forth in some of the appended claims. Although specific terms are employed herein, they are used in a generic and descriptive sense only and not for purposes of limitation.

That which is claimed:

1. A method comprising:
generating a first plurality of aerial vehicle (AV) constellations about a geographic area, each AV constellation comprising a set number of AVs with each AV of the set number of AVs associated with a randomly selected respective location, wherein the first plurality of AV constellations is determined based at least in part on respective current locations of the set number of AVs and obstacle information for the geographic area, wherein each of the set number of AVs is configured to enable positioning within the geographic area;
determining respective positioning scores for AV constellations of the first plurality of AV constellations, wherein the respective positioning score for an AV constellation of the first plurality of AV constellations is determined based at least in part on a measure of positioning accuracy for at least one position of interest within the geographic area;
generating a second plurality of AV constellations based on the first plurality of AV constellations and the respective positioning scores, wherein generating an AV constellation of the second plurality of AV constellations comprises:
selecting a first AV constellation randomly from the first plurality of AV constellations based on the respective positioning scores for the first plurality of AV constellations, and
modifying the first AV constellation by adjusting one or more respective locations of the set number of AVs by respective randomly selected location perturbations;
determining the respective positioning scores for the AV constellations of the second plurality of AV constellations; and
selecting a preferred AV constellation from a group of selectable constellations based on the respective positioning score of the preferred AV constellation, the group of selectable constellations generated based at least in part on one or more of the first plurality of AV constellations or the second plurality of AV constellations.

2. The method of claim 1, further comprising determining respective travel paths from the respective current locations of the set number of AVs to respective locations of the set number of AVs corresponding to the preferred AV constellation.

3. The method of claim 2, further comprising providing respective instructions for receipt by respective AVs of the set number of AVs, the respective instructions configured to cause the respective AVs to each traverse one of the respective travel paths.

4. The method of claim 3, further comprising:
receiving determined obstacle data provided by an AV of the set number of AVs, the determined obstacle data determined by the AV as the AV traversed a respective travel path; and
incorporating the determined obstacle data into the obstacle information for the geographic area.

5. The method of claim 1, wherein a probability that the first AV constellation is selected from the first plurality of random AV constellations is determined based on the respective positioning score associated with the first AV constellation.

6. The method of claim 1, wherein the geographic area comprises a building or venue.

7. The method of claim 6, wherein the obstacle information for the geographic area comprises an indication of dimensions of building or venue and a positioning of the building or venue in the geographic area.

8. The method of claim 1, wherein the at least one position of interest is a position of a device located within the geographic area.

9. The method of claim 1, wherein each AV of the set number of AVs comprises one or more sensors configured to determine a three-dimensional location of the AV.

10. The method of claim 1, wherein the measure of positioning accuracy is a geometric dilution of precision (GDOP) value.

11. The method of claim 1, further comprising iterating the steps of generating the second plurality of AV constellations and determining the respective positioning scores for the constellations of the second plurality of AV constellations until a convergence requirement is met, wherein the group of selectable constellations comprises a final second plurality of AV constellations generated during a final iteration of generating the second plurality of AV constellations.

12. The method of claim 1, wherein at least one of the first plurality of AV constellations or the second plurality of AV constellations is filtered so as to only contain AV constellations that, for each AV of the set number of AVs, at least one potential travel path exists from the current location of the AV to a new AV location of the respective AV constellation, the at least one potential travel path having a length that is no longer than at least one (a) a set distance or (b) a set percentage longer than a shortest distance path from the current location of the AV to the AV location and having no obstacles located along the at least one potential travel path.

13. The method of claim 12, wherein the set distance is equal to zero or the set percentage is equal to zero.

14. The method of claim 1, wherein the obstacle information is a binary three-dimensional grid comprising a plurality of grid elements each corresponding to a respective volume of the geographic area and each associated with a respective binary value, the respective binary value configured to indicate whether the corresponding respective volume comprises an obstacle.

15. The method of claim 1, further comprising:
receiving at least one updated position of interest;
determining a new preferred AV constellation based on the at least one updated position of interest;
determining new respective travel paths from the respective current locations of the set number of AVs to the respective locations of the set number of AVs corresponding to the new preferred AV constellation; and
providing new respective instructions for receipt by the respective AVs, the new respective instructions configured to cause the respective AVs to each traverse one of the new respective travel paths.

16. An apparatus comprising at least one processor and at least one memory storing computer program code, the at least one memory and the computer program code configured to, with the processor, cause the apparatus to at least:
generate a first plurality of aerial vehicle (AV) constellations about a geographic area, each AV constellation comprising a set number of AVs with each AV of the set number of AVs associated with a randomly selected respective location, wherein the first plurality of AV constellations is determined based at least in part on respective current locations of the set number of AVs and obstacle information for the geographic area, wherein each of the set number of AVs is configured to enable positioning within the geographic area;
determine respective positioning scores for AV constellations of the first plurality of AV constellations, wherein the respective positioning score for an AV constellation of the first plurality of AV constellations is determined based at least in part on a measure of positioning accuracy for at least one position of interest within the geographic area;
generate a second plurality of AV constellations based on the first plurality of AV constellations and the respective positioning scores, wherein generating an AV constellation of the second plurality of AV constellations comprises:
selecting a first AV constellation randomly from the first plurality of AV constellations based on the respective positioning scores for the first plurality of AV constellations, and
modifying the first AV constellation by adjusting one or more respective locations of the set number of AVs by respective randomly selected location perturbations;
determine the respective positioning scores for the AV constellations of the second plurality of AV constellations; and
select a preferred AV constellation from a group of selectable constellations based on the respective positioning score of the preferred AV constellation, the group of selectable constellations generated based at least in part on one or more of the first plurality of AV constellations or the second plurality of AV constellations.

17. The apparatus of claim 16, wherein the at least one memory and the computer program code are further configured to, with the processor, cause the apparatus to at least:
determine respective travel paths from the respective current locations of the set number of AVs to respective locations of the set number of AVs corresponding to the preferred AV constellation; and
provide respective instructions for receipt by respective AVs of the set number of AVs, the respective instructions configured to cause the respective AVs to each traverse one of the respective travel paths.

18. The apparatus of claim 16, wherein a probability that the first AV constellation is selected from the first plurality of random AV constellations is determined based on the respective positioning score associated with the first AV constellation.

19. The apparatus of claim 16, wherein the geographic area comprises a building or venue and the at least one position of interest is a position of a device located within the geographic area.

20. A computer program product comprising at least one non-transitory computer-readable storage medium having computer-readable program code portions stored therein, the computer-readable program code portions comprising executable portions configured, when executed by a processor of an apparatus, to cause the apparatus to:
generate a first plurality of aerial vehicle (AV) constellations about a geographic area, each AV constellation comprising a set number of AVs with each AV of the set number of AVs associated with a randomly selected respective location, wherein the first plurality of AV constellations is determined based at least in part on respective current locations of the set number of AVs and obstacle information for the geographic area, wherein each of the set number of AVs is configured to enable positioning within the geographic area;
determine respective positioning scores for AV constellations of the first plurality of AV constellations, wherein the respective positioning score for an AV constellation of the first plurality of AV constellations is determined based at least in part on a measure of positioning accuracy for at least one position of interest within the geographic area;
generate a second plurality of AV constellations based on the first plurality of AV constellations and the respective positioning scores, wherein generating an AV constellation of the second plurality of AV constellations comprises:
selecting a first AV constellation randomly from the first plurality of AV constellations based on the respective positioning scores for the first plurality of AV constellations, and
modifying the first AV constellation by adjusting one or more respective locations of the set number of AVs by respective randomly selected location perturbations;
determine the respective positioning scores for the AV constellations of the second plurality of AV constellations; and
select a preferred AV constellation from a group of selectable constellations based on the respective positioning score of the preferred AV constellation, the group of selectable constellations generated based at least in part on one or more of the first plurality of AV constellations or the second plurality of AV constellations.
